(19) United States
(12) Patent Application Publication
(10) Pub. No.: US 2020/0352095 A1
(43) Pub. Date: Nov. 12, 2020

(54) BLADES, RECEPTACLES AND SPRING COLLAR CONNECTORS FOR USE WITH ROTARY HEAD TRIMMER ASSEMBLY AND LAWNMOWER

(71) Applicant: Orlando Jerez, Kenner, LA (US)

(72) Inventor: Orlando Jerez, Kenner, LA (US)

(21) Appl. No.: 16/406,710

(22) Filed: May 8, 2019

(51) Int. Cl. A01D 34/73

(52) U.S. Cl. CPC A01D 34/736; A01D 2101/00; A01D 34/733

(57) ABSTRACT

A cutting blade for use with a rotary trimmer head assembly configured with one or more swiveling blade receptacles is disclosed. The blade has a trimmer head connecting end portion defining a blade mount aperture adapted to receive the swiveling blade receptacle, and the blade has a cutting end portion. The connecting end portion comprises a spring collar assembly sized and configured to firmly and removably receive and secure a portion of an outer cylindrical surface of the swiveling blade receptacle. The spring collar assembly has a pair of opposing levers having two ends. Each lever has a handle and a curved jaw. The curved jaws define a collar aperture in coaxial alignment with the blade mount aperture. Preferably, the levers are fixedly connected to respective pivot arms radially extending from a pivotal abutment disposed intermediate the two ends of each lever, wherein squeezing together said handles of the levers increases a diameter of the collar aperture.

### TECHNICAL FIELD

The present disclosure relates to rotary head assembly apparatuses, lawn mower apparatuses and cutting blades designed for use with rotary head assemblies and lawn mower assemblies. More particularly, the present disclosure relates to rotary head and lawn mower assembly apparatuses configured to easily replace cutting members necessary to cut unwanted plants and cutting blades thereof.

### BACKGROUND

Presently, there are trimming apparatuses known in the art having a rotatable, attachable head for attachment to a powered device, with the head carrying a series of trimmer lines extending axially out about the periphery of the head. Examples of such weed trimming apparatuses include spool and “bump ‘n’ feed” weed trimming apparatuses and conventional rotatable lawn mowers with continuous-feed trimming line, automatic-feed trimmer head, and trimming apparatuses using fixed-length pieces of trimming line or blades. However, such weed trimming apparatuses and lawn mower apparatuses have certain drawbacks which have gone largely unaddressed in this technical field.

Both the “bump ‘n’ feed” and automatic trimmer head relies on an internal spool with trimmer line reserves. Stress on these apparatuses' trimming lines will cause it break from time to time during use. Because of their designs, the trimmer lines often get twisted, tangled, or buried within the spool making it difficult to dispense the proper line length for cutting. As a result, the trimmer head must then be disassembled, the trimmer string unwound and again rewound in the proper manner before the trimmer head will again work as designed. This process is difficult, labor intensive, and highly time consuming.

The conventional lawn mower relies on fixed blades or complicated replaceable blades. Stress on these apparatuses' blades will cause them to break and become dull from time to time during use. Because of their designs, the blades often become dull, damaged, or broken making it difficult to cut grass or other unwanted vegetation. As a result, the lawn mower assembly must then be disassembled, the blades removed, and the assembly must then be reassembled in the proper manner before the lawn mower will again work as designed. This process is difficult, labor intensive, and highly time consuming.

To address the aforementioned problems of the conventional “bump ‘n’ feed”, automatic trimmer heads, and conventional rotary lawn mower, blades or fixed-length trimmer line pieces have been incorporated into the trimmer head and the rotary lawn mower assemblies. As the blades become dull, damaged, or broken, or the trimmer lines break, often times, it requires additional tools and/or a lot of time to replace the worn or broken pieces. Thus, a need exists for a rotary apparatus that does not tangle, twist, or bind cutting members such as the trimmer lines. Furthermore, a need exists for a rotary apparatus that does not have to be disassembled to have new strings or other types of cutting members added. Lastly, a need exists for a rotary apparatus which requires little time and effort to replace the cutting members such as trimmer lines or cutting blades. These needs are met by the present invention as described and claimed below.

### SUMMARY OF THE INVENTION

From the foregoing, it is apparent there is still a great and long-felt need for a cutting blade, in particular a cutting blade for use with a rotary head assembly and for a conventional rotary lawn mower assembly, that provides quick and easy insertion of a cutting member in order to resume operation as well as simple and efficient removal of the cutting member when replacing it. The present invention addresses the foregoing need, amongst other needs, in a highly unique and facile way. Thus, it is one prospect of the present invention to provide one or more novel devices of simple but effective construction which can be applied to many environments to efficiently and effectively provide quick and easy insertion and removal of a cutting member for use with a rotary head assembly and a rotary lawn mower assembly. The cutting member of the present invention can be flexible (e.g. wires, strands, etc.), semi-rigid (e.g. plastic blades), or rigid (e.g. metal blades) and may be made of any material and in any shape capable of cutting unwanted plants such as weeds. Non-limiting examples of cutting member materials include plastics (e.g. nylon), metals, metal alloys, and combinations thereof.

The following presents a simplified summary of the present disclosure in a simplified form as a prelude to the more detailed description that is presented herein.

In accordance with embodiments of the invention, a cutting blade for use with a rotary trimmer head assembly configured with one or more swiveling blade receptacles is provided. The blade has an elongated body extending along a longitudinal axis. In a preferred embodiment, the body forms two opposing planar surfaces. The body has a trimmer head connecting end portion and a cutting end portion. The connecting end portion defines a blade mount aperture adapted to receive the swiveling blade receptacle and the cutting end portion forms at least one cutting edge. In such preferred embodiment, the connecting end portion comprises a spring collar assembly sized and configured to firmly and removably receive and secure a portion of an outer cylindrical surface of the swiveling blade receptacle. The spring collar assembly has a pair of opposing levers having two ends. Each lever has a handle toward one of the two ends and a curved jaw toward the other of the ends. The curved jaws define a collar aperture in alignment with the blade mount aperture. The levers have a pivotal abutment intermediate the two ends of the levers. Squeezing together the handles of the levers increases a diameter of the collar aperture.

In another embodiment, the cutting end portion of the cutting blade forms two opposed cutting edges.

In another preferred embodiment of the invention, a spring collar locking assembly for use with a rotary trimmer head assembly configured with one or more swiveling receptacles is provided. In such preferred embodiment, the spring collar locking assembly has a planar body member defining a blade mount aperture adapted to receive the swiveling blade receptacle. The planar body is adapted to receive one or more tool members. A pair of opposing levers are mounted to the planar body with each lever having two ends. Each lever has a handle toward one of the ends and a curved jaw toward the other of the ends. The curved jaws define a collar aperture in alignment with the blade mount aperture. The levers have a pivotal abutment intermediate the two ends of the levers. Squeezing together the handles of the levers increases a diameter of the collar aperture.

In one embodiment, the pivotal abutment is two fold at the vertex of the V-shape.

In one embodiment, the tool member is a cutting blade.

In another embodiment, the tool member is a trimmer line.

In yet another embodiment, the tool member is a blower blade.

In another embodiment, the tool member is a broom.

In yet another embodiment, the tool member is a propeller.

In accordance with embodiments of the invention, a trimmer member receptacle configured for use with a rotary trimmer head assembly is presented, having a cylindrical body. The cylindrical body has an upper portion opposite a lower portion. The upper portion defines a channel adapted to receive a spring collar locking assembly. The lower portion has a cylindrical flange configured for attachment to the rotary trimmer head assembly.

In one embodiment, the cylindrical body further defines a passage therethrough. The passage is defined by a top wall, a bottom wall and a pair of opposing side walls connecting the top and bottom walls.

In another embodiment, the trimmer member receptacle is fixed to the rotary trimmer head assembly.

In yet another embodiment, the trimmer member receptacle is dynamically connected to the rotary trimmer head assembly.

In accordance with embodiments of the invention, there is provided a lawn mower blade assembly for use with a rotary lawn mower configured with a motor rotating horizontally around a vertical axis. The lawn mower blade assembly includes a rotatable and preferably elongated planar body defining a centrally disposed drive mount opening configured for receiving a lawn mower motor drive shaft. The planar body has two or more elongated arms extending outwardly therefrom and each arm has a proximal end opposite a distal end. The distal end of each arm defines a receptacle aperture configured to receive a swiveling blade receptacle therethrough.

The lawn mower blade assembly includes at least one swiveling blade receptacle having a cylindrical body, which is configured to be removably inserted through the receptacle aperture. In one embodiment, the swiveling receptacle is freely spinnable within the receptacle aperture. In another embodiment, the blade receptacle is fixed within the receptacle aperture for a swiveling blade. The cylindrical body has an upper portion opposite a lower portion, the upper portion defines an annular ring channel. The lower portion includes a cylindrical flange extending radially outwardly from the body. The flange is configured to restrain the swiveling blade receptacle from moving through the receptacle aperture.

The lawn mower blade assembly includes a cutting blade having an elongated body. The elongated body has a cutting end portion and a connecting end portion. The cutting end portion forms at least one cutting edge and the connecting end portion defines a blade mount aperture adapted to receive the swiveling blade receptacle. The connecting end portion includes a spring collar assembly having a pair of opposing levers having two ends, each lever has a handle toward one of the ends thereof and a curved jaw toward the other ends. The curved jaws define a collar aperture in coaxial alignment with the blade mount aperture. The levers have a pivotal abutment intermediate the two ends of the levers and squeezing together the handles of the levers increases a diameter of the collar aperture. The jaws which form the collar aperture are preferably sized and configured to firmly and removably engage the annular ring channel of the upper portion of the swiveling blade receptacle to removably connect the blade to the swiveling blade receptacle, such as, to secure the blade against vertical movement relative to the receptacle. In a preferred embodiment, the cutting blade is secured to the rotatable planar body of the lawn mower blade when the curved jaws engage the annular ring of the swiveling blade receptacle. Preferably, the collar aperture formed by the jaws is coaxially aligned concentric with the receptacle aperture, such that the swiveling blade receptacle extends therethrough in coaxial alignment with both the receptacle aperture and the collar aperture. The mount aperture of the blade retains the blade against centrifugal forces exerted by the spinning of the planar body when driven by the motor and drive shaft during operation of the lawn mower.

In one embodiment, the connecting end portion of the cutting blade forms a washer and the washer forms the blade mount aperture.

In a preferred embodiment, the swiveling blade receptacle is freely spinnable within the receptacle aperture and coaxially aligned concentric with the receptacle aperture.

In one embodiment, a top end of the upper portion of the swiveling blade receptacle is beveled.

In another embodiment, the rotatable planar body has three radially extending arms, each arm defining a receptacle aperture configured to receive a swiveling blade receptacle therethrough, and each radially extending arm is spaced equally.

In yet another embodiment, the rotatable planar body has four radially extending arms, each arm defining a receptacle aperture configured to receive a swiveling blade receptacle therethrough, each radially extending arm is spaced equally.

In yet another embodiment, at least one of said two or more elongated arms has a longitudinal axis that departs at an acute angle relative to the planar body. The distal end of the at least one of the two or more elongated arms departs at an angle relative to the longitudinal axis and the distal end has a horizontal plane parallel to the planar body.

In one embodiment, the lawn mower blade assembly includes an elongated batten disposed along at least a top or bottom surface of the rotatable planar body and two or more elongated extending arms.

In another embodiment, the lawn mower blade assembly includes an elongated batten formed along a top surface of the rotatable planar body and two or more elongated extending arms. In such embodiment, the batten defines a channel along a bottom surface of the rotatable planar body and two or more elongated extending arms.

In another embodiment, the cutting end portion forms two opposed cutting edges.

In yet another embodiment, the cutting end portion of the cutting blade comprises a tip at the end thereof. The tip has a corner opposite to the at least one cutting edge and the corner is tilted upwardly to define a sail having a face inclined inwardly at the end of the cutting blade.

In yet another embodiment, the cutting blade has a tip at the end thereof defining the end of the cutting end portion. The tip has corners opposite the cutting edge and the corners are tilted upwardly to define sails having faces inclined inwardly towards the ends of the cutting blade.

In accordance with embodiments of the invention, there is provided a cutting blade for use with a lawn mower blade assembly. The cutting blade includes an elongated body having a cutting end portion and a connecting end portion. The cutting end portion forms at least one cutting edge. The connecting end portion defines a blade mount aperture adapted to receive a swiveling blade receptacle. The connecting end portion has a spring collar assembly including a pair of opposing levers having two ends, each lever has a handle toward one of the ends thereof and a curved jaw toward the other ends. The curved jaws define a collar aperture in coaxial alignment with the blade mount aperture. The levers have a pivotal abutment intermediate the two ends of the levers. Squeezing together the handles of the levers increases a diameter of the collar aperture. The curved jaws are sized and configured to firmly and removably engage and secure an annular ring channel of an upper portion of a swiveling blade receptacle.

In one embodiment, the connecting end portion of the cutting blade forms a washer, and the washer forms the blade mount aperture.

In another embodiment, the cutting end portion forms two opposed cutting edges.

In yet another embodiment, the cutting end portion of the cutting blade comprises a tip at the end thereof. The tip has a corner opposite to the at least one cutting edge and the corner is tilted upwardly to define a sail having a face inclined inwardly at the end of the cutting blade.

In accordance with embodiments of the invention, there is provided a cutting blade assembly for use with a rotary lawn mower configured with a motor rotating horizontally around a vertical axis. The cutting blade assembly includes at least one swiveling blade receptacle having a cylindrical body adapted to be removably inserted into a receptacle aperture of a cutting blade. The cylindrical body has an upper portion opposite a lower portion, the upper portion defines an annular ring channel, and the lower portion includes a cylindrical flange extending radially outwardly from the body.

The cutting blade assembly includes a cutting blade having an elongated body, which has a cutting end portion and a connecting end portion. The cutting end portion forms at least one cutting edge and the connecting end portion defines a blade mount aperture adapted to receive the swiveling blade receptacle. The connecting end portion includes a spring collar assembly having a pair of opposing levers having two ends, each lever having a handle toward one of the ends thereof and a curved jaw toward the other ends. The curved jaws define a collar aperture in coaxial alignment with the blade mount aperture. The levers have a pivotal abutment intermediate the two ends of the levers and squeezing together the handles of the levers increases a diameter of the collar aperture. The jaws are sized and configured to firmly and removably engage and secure the annular ring channel of the upper portion of the swiveling blade receptacle and the cutting blade is adapted to be secured to the swiveling blade receptacle, in order to connect to, for instance, a rotatable planar body, a rotary cutter head, etc., when the curved jaws engage the annular ring of the swiveling blade receptacle.

In accordance with embodiments of the invention, there is provided a cutting blade for use with a rotary trimmer head assembly configured with one or more swiveling blade receptacles. The blade includes an elongated body extending along a longitudinal axis forming two opposing planar surfaces. The body has a trimmer head connecting end portion and a cutting end portion. The connecting end portion defines a blade mount aperture adapted to receive the swiveling blade receptacle. The cutting end portion forms at least one cutting edge.

The connecting end portion has an inverse spring collar assembly sized and configured to firmly and removably receive and secure a portion of an outer cylindrical channel of the swiveling blade receptacle. The inverse spring collar assembly includes a clamp having a ring portion with opposing arms defining a clamp opening. The opposing arms have respective extension arms extending in overlapping relation with one another and the extension arms constitute actuating members by which an expanding force can be applied to the ends of the ring portion for flexing the clamp to an expanded or dilated open position. In the expanded open position, the clamp is adapted to readily receive the swiveling blade receptacle and a release of the expanding force applied to the opposing arms permits contraction of the clamp into the channel of the swiveling blade receptacle.

In one embodiment, the proximal end of the clamp defines an aperture configured to receive a pin.

In another embodiment, the cutting blade includes a connector disposed at the proximal end of the clamp configured to mate with a channel defined by a center post of the rotary trimmer head assembly.

In yet another embodiment, at least one or more opposable finger levers are disposed at the ends of the opposing arms.

In accordance with embodiments of the invention, there is provided an inverse spring collar trimmer member retention assembly sized and configured to firmly and removably receive and secure a trimmer member to a swiveling blade receptacle. The inverse spring collar assembly has a clamp having a ring portion having a pair of opposite ends. The clamp has a distal end opposite a proximal end, and the proximal end of the clamp defines an aperture configured to receive a pin vertically extending from a rotary trimmer head. The clamp defines a clamp opening.

A pair of opposing arms are disposed at the distal end of the clamp. The opposing arms are connected with opposite ends of the ring portion and extend outwardly in substantially opposite directions and in a crossing or overlapping relation to each other. The arms constitute actuating members by which an expanding force can be applied to the ends of the ring member for flexing the clamp to an expanded or dilated open position. When in the expanded open position, the clamp is adapted to readily receive the swiveling blade receptacle. A release of the expanding force applied to the opposing arms permits contraction of the clamp into a channel of the swiveling blade receptacle.

In accordance with embodiments of the invention, there is provided an inverse spring collar trimmer member retention assembly sized and configured to firmly and removably receive and secure a trimmer member to a swiveling blade receptacle. The inverse spring collar assembly includes a clamp having a ring portion. The ring portion has a pair of opposite ends. The clamp has a distal end opposite a proximal end. The proximal end comprises a connector disposed at the proximal end of the clamp and the connector is configured to mate with a channel defined by a center post of the rotary trimmer head assembly. The clamp defines a clamp opening.

A pair of opposing arms is disposed at the distal end of the clamp. The opposing arms are connected with opposite ends of the ring portion and extend outwardly in substantially opposite directions and in a crossing or overlapping relation to each other. The arms constitute actuating members by which an expanding force can be applied to the ends of the ring member for flexing the clamp to an expanded or dilated open position. When the clamp is in the expanded open position, the clamp is adapted to readily receive the swiveling blade receptacle. A release of the expanding force applied to the opposing arms permits contraction of the clamp into a channel of the swiveling blade receptacle.

In accordance with embodiments of the invention, there is provided an inverse spring collar trimmer member retention assembly sized and configured to firmly and removably receive and secure a portion of an outer cylindrical channel of a swiveling blade receptacle. The inverse spring collar assembly includes an elongated body having a distal end opposite a proximal end, the body has an upper elongated member and a lower elongated member. A washer is disposed at the proximal end of the lower elongated member and configured to allow for the passage of the swiveling blade receptacle therethrough. An inverse spring collar assembly is disposed at the proximal end of the upper elongated member.

The spring collar assembly includes a clamp having a ring portion with opposing arms defining a clamp opening. The opposing arms have respective extension arms extending in overlapping relation with one another and the extension arms constitute actuating members by which an expanding force can be applied to the ends of the ring portion for flexing the clamp to an expanded or dilated open position. When in the expanded open position, the clamp is adapted to readily receive the swiveling blade receptacle. A release of the expanding force applied to the opposing arms permits contraction of the clamp into the channel of the swiveling blade receptacle.

In one embodiment, a connector is disposed at the proximal end of the body and the connector is configured to mate with a channel defined by the rotary trimmer head assembly.

These and other features, aspects and advantages of the present invention will become better understood with reference to the following description and appended claims.

### BRIEF DESCRIPTION OF THE DRAWINGS

Illustrative embodiments of the present invention are described herein with reference to the accompanying drawings, in which like numerals throughout the figures identify substantially similar components, in which:

FIG. 1 is a top front left perspective view of an exemplary cutting member attached to a rotary trimmer head assembly configured with one or more swiveling blade receptacles, in accordance with embodiments of the invention;

FIG. 2 is a top left side perspective view of an exemplary cutting member, in accordance with embodiments of the invention;

FIG. 3 is top right back perspective view of an exemplary cutting member attached to a swiveling blade receptacle, according to a preferred embodiment of the invention;

FIG. 4 is a top left front perspective view thereof;

FIG. 5 is a bottom view thereof;

FIG. 6A is a top left perspective view of an exemplary spring collar assembly, according to preferred embodiments of the invention;

FIG. 6B is a top left perspective view thereof in an exemplary open position, according to preferred embodiments of the invention;

FIG. 7 is a back elevation view thereof;

FIG. 8 is a side elevation view thereof;

FIG. 9 is a side elevation view of an exemplary cutting member, in accordance with embodiments of the invention;

FIG. 10 front elevation view thereof;

FIG. 11 is a left elevation side view, in cross section, thereof;

FIG. 12 is a top view of an exemplary cutting member attached to a swiveling blade receptacle, according to preferred embodiments of the invention;

FIG. 13 is a right elevation side view, in cross section, thereof;

FIG. 14 is a right elevation side view thereof;

FIG. 15 is a front elevation view, in cross section, thereof;

FIG. 16 is a left elevation view thereof;

FIG. 17 is a back elevation view thereof;

FIG. 18 is a front elevation view thereof;

FIG. 19 is a top left back perspective view thereof;

FIG. 20 is a front left bottom perspective view thereof;

FIG. 21 is a back left bottom perspective view thereof;

FIG. 22 is a top front left perspective view thereof;

FIG. 23 is a back elevation view thereof;

FIG. 24 is a left side elevation view thereof;

FIG. 25 is a front elevation view thereof;

FIG. 26 is a top left perspective view of an exemplary cutting member, in accordance with embodiments of the invention;

FIG. 27 is a top left perspective view of an exemplary tool member attached to a rotary trimmer head assembly configured with one or more swiveling receptacles, in accordance with embodiments of the invention;

FIG. 28 is a top left perspective view of an exemplary tool member, in accordance with embodiments of the invention;

FIG. 29 is a top left perspective view of an exemplary tool member attached to a rotary trimmer head assembly configured with one or more swiveling receptacles, in accordance with embodiments of the invention;

FIG. 30 is a top left perspective view of an exemplary tool member, in accordance with embodiments of the invention;

FIG. 31 is a top left perspective view of an exemplary tool member attached to a rotary trimmer head assembly configured with one or more swiveling receptacles, in accordance with embodiments of the invention;

FIG. 32 is a top left perspective view of an exemplary tool member, in accordance with embodiments of the invention;

FIG. 33 is a top left perspective view of an exemplary tool member attached to a rotary trimmer head assembly configured with one or more swiveling receptacles, in accordance with embodiments of the invention;

FIG. 34 is a top left perspective view of an exemplary tool member, in accordance with embodiments of the invention;

FIG. 35 is a top left perspective view of an exemplary tool member attached to a rotary trimmer head assembly configured with one or more swiveling receptacles, in accordance with embodiments of the invention;

FIG. 36 is a top left perspective view of an exemplary tool member, in accordance with embodiments of the invention;

FIG. 37 is a bottom front perspective view of an exemplary trimmer member receptacle, in accordance with embodiments of the invention;

FIG. 38 is a front elevation view thereof;

FIG. 39 is a side elevation view thereof;

FIG. 40 is a side elevation view, in cross section, thereof;

FIG. 41 is a top front perspective view thereof;

FIG. 42 is a top back perspective view thereof;

FIG. 43 is a bottom view thereof;

FIG. 44 is a top view thereof;

FIG. 45 is a side elevation view of an exemplary lawn mower blade assembly attached to an exemplary lawn mower, in accordance with embodiments of the invention;

FIG. 46 is a top front left perspective view of an exemplary lawn mower blade assembly, in accordance with embodiments of the invention;

FIG. 47 is a top front left perspective view of an exemplary lawn mower blade assembly, illustrating the rotational movement of the mower blade, in accordance with embodiments of the invention;

FIG. 48 is a top front left perspective exploded view of an exemplary lawn mower blade assembly, in accordance with embodiments of the invention;

FIG. 49A is a top front perspective view of an exemplary lawn mower blade assembly, illustrating two planar bodies sandwiched together, in accordance with embodiments of the invention;

FIG. 49B is a front elevation view of the two respective planar bodies of an exemplary lawn mower blade assembly, in accordance with embodiments of the invention;

FIG. 49C is an exploded view thereof;

FIG. 49D is a top front perspective view of an exemplary double ended receptacle disposed within an exemplary lawn mower blade assembly, in accordance with embodiments of the invention;

FIG. 49E is a top front perspective view thereof, illustrating multiple blade placement heights of exemplary mower blades, in accordance with embodiments of the invention;

FIG. 50 is a top view of an exemplary cutting blade with an inverse spring collar assembly molded thereon, in accordance with embodiments of the invention;

FIG. 51 is a left side elevation view, in cross section along section A-A thereof;

FIG. 52 is a left side elevation view thereof;

FIG. 53 is a back elevation view thereof;

FIG. 54 is a top back left perspective view thereof;

FIG. 55 is a top front right perspective view thereof;

FIG. 56 is a top front left perspective view thereof;

FIG. 57 is a back top left perspective view thereof;

FIG. 58 is a back top right perspective view thereof;

FIG. 59 is a left bottom back perspective view thereof;

FIG. 60 is a right side elevation view thereof;

FIG. 61 is a front elevation view thereof;

FIG. 62 is a bottom view thereof;

FIG. 63 is a left side elevation view thereof;

FIG. 64 is a front elevation view, in cross section along section B-B thereof;

FIG. 65 is a top view of an exemplary cutting member with an inverse spring collar assembly molded thereon attached to a rotary trimmer head assembly configured with one or more swiveling blade receptacles, in accordance with embodiments of the invention;

FIG. 66 is a left side elevation view thereof;

FIG. 67 is a top left perspective view thereof;

FIG. 68 is a front elevation view thereof;

FIG. 69 is a top front left perspective view of an exemplary cutting blade with an inverse spring collar assembly molded thereon, in accordance with embodiments of the invention;

FIG. 70 is a top view thereof;

FIG. 71 is a back elevation view of an exemplary inverse spring collar, in accordance with embodiments of the invention;

FIG. 72 is a top view thereof;

FIG. 73 is a top right back perspective view thereof;

FIG. 74 is a right side elevation view thereof;

FIG. 75 is a top right back perspective view thereof;

FIG. 76 is a front elevation view thereof;

FIG. 77A is a top view thereof;

FIG. 77B is a top view thereof in an exemplary open position, according to preferred embodiments of the invention;

FIG. 78 is a top right back perspective view of an exemplary inverse spring collar, in accordance with embodiments of the invention;

FIG. 79 is a top left front perspective view thereof;

FIG. 80 is a right side elevation view thereof;

FIG. 81 is a front elevation view thereof;

FIG. 82 is a left side elevation view thereof;

FIG. 83 is a bottom view thereof;

FIG. 84 is a top left front perspective view of an exemplary cutting member with an inverse spring collar assembly attached to a rotary trimmer head assembly configured with a vertical rod member and one or more swiveling blade receptacles, in accordance with embodiments of the invention;

FIG. 85 is top back left perspective view thereof;

FIG. 86 is a right side elevation view thereof;

FIG. 87 is a bottom view thereof;

FIG. 88 is a back elevation view thereof;

FIG. 89 is a top right back perspective view of an exemplary inverse spring collar configured with a rotary trimmer head assembly channel connector, in accordance with embodiments of the invention;

FIG. 90 is a back elevation view thereof;

FIG. 91 is a left side elevation view thereof;

FIG. 92 is a left side elevation view thereof;

FIG. 93 is a top left front perspective view thereof;

FIG. 94 is a bottom view thereof;

FIG. 95 is top left front perspective view of an exemplary inverse spring collar configured with a rotary trimmer head assembly channel connector and exemplary cutting member attached to a rotary trimmer head assembly configured with one or more swiveling blade receptacles and central channel, in accordance with embodiments of the invention;

FIG. 96 is a left side perspective view thereof;

FIG. 97 is a top view thereof;

FIG. 98 is a right side elevation view thereof;

FIG. 99 is a bottom view thereof; and

FIG. 100 is perspective view of an exemplary spring collar assembly connected to an end of a tongue of a cargo trailer, shown to be removably connected to an automotive trailer hitch ball.

### FURTHER DETAILED DESCRIPTION OF THE INVENTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

As used herein, “axis” means a real or imaginary straight line about a three-dimensional body. A “vertical axis” means an axis perpendicular to the ground (or put another way, an axis extending upwardly and downwardly). A “horizontal axis” means an axis parallel to the ground.

As used herein, homogeneous is defined as the same in all locations, and a homogeneous material is a material of uniform composition throughout that cannot be mechanically separated into different materials. Examples of “homogeneous materials” are certain types of plastics, ceramics, glass, metals, alloys, paper, board, resins, high-density polyethylene and rubber.

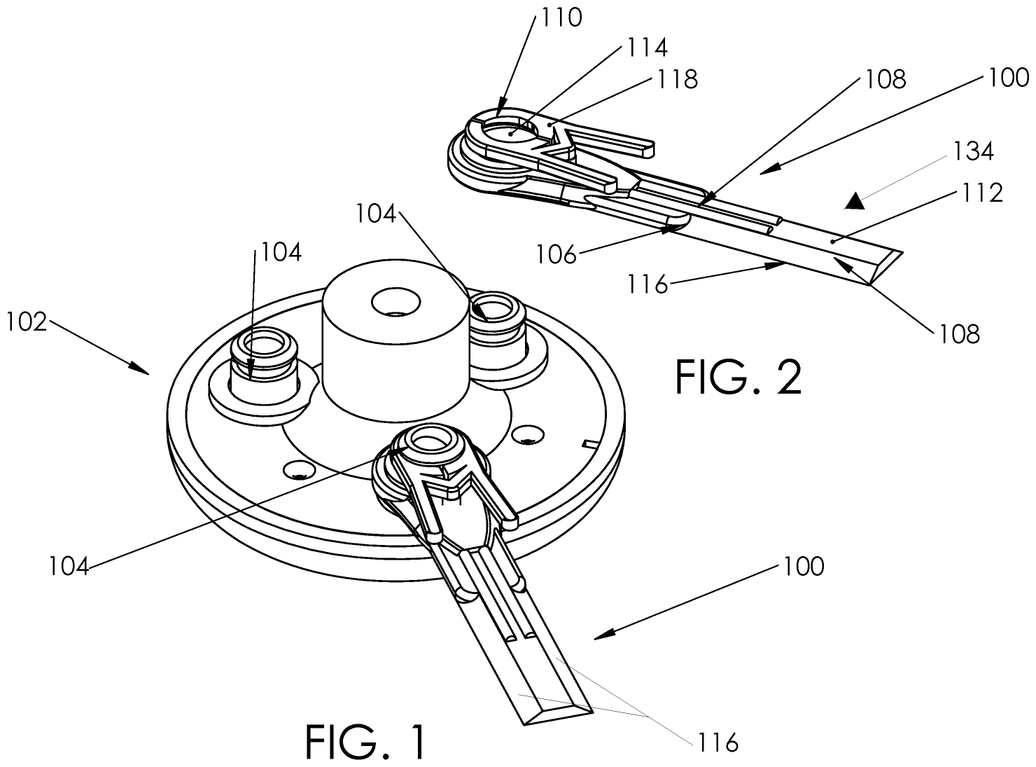

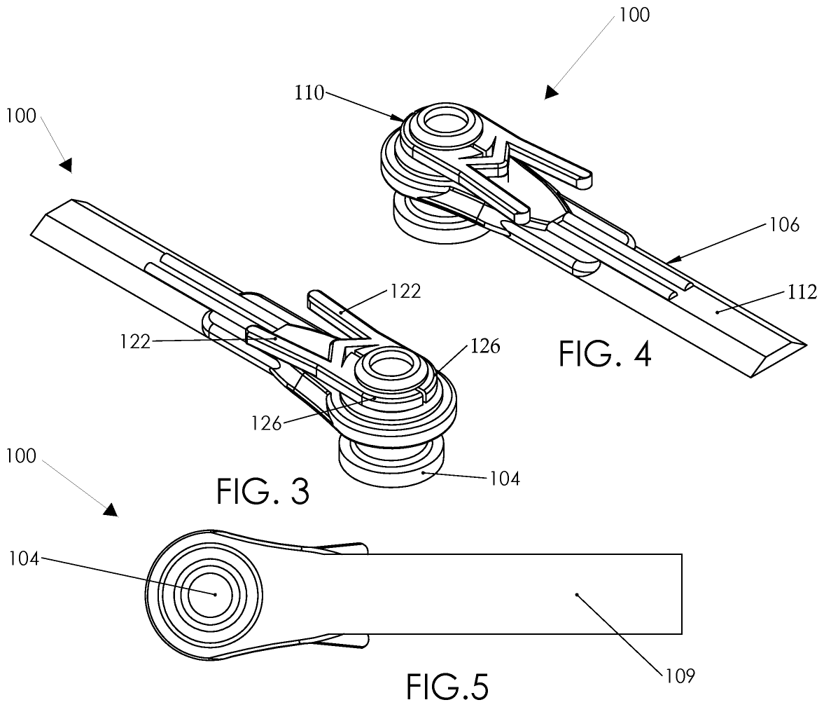

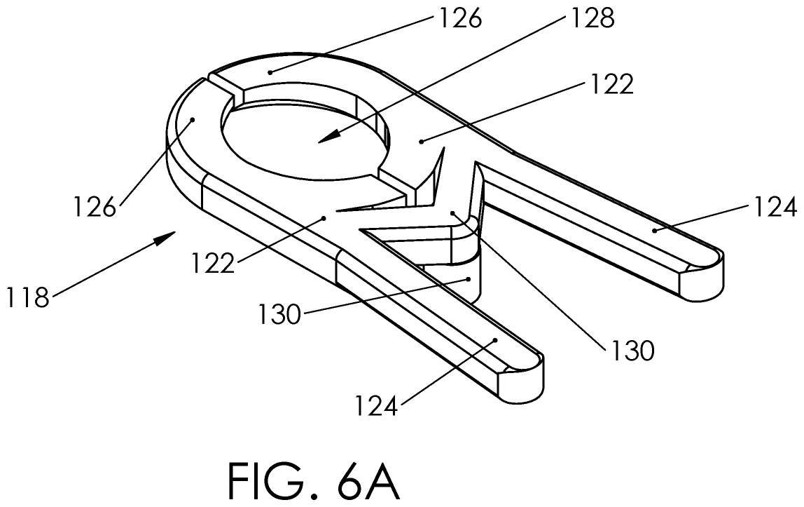

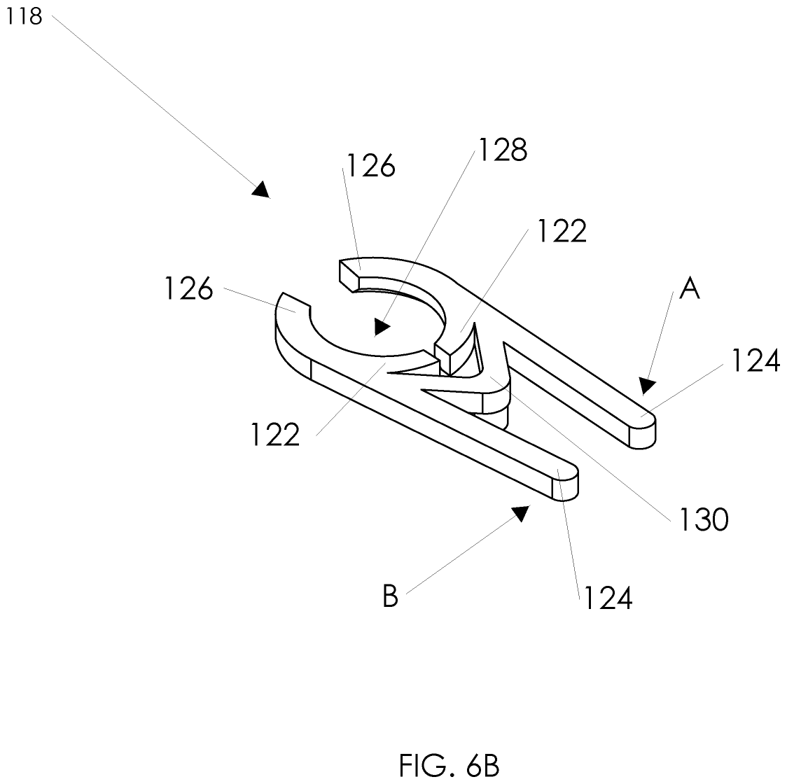

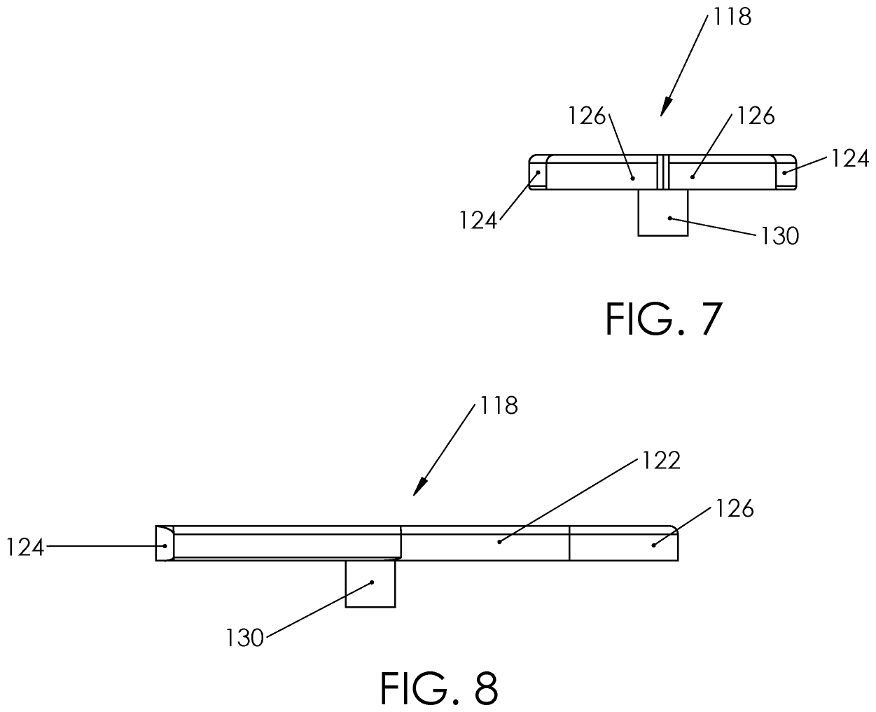

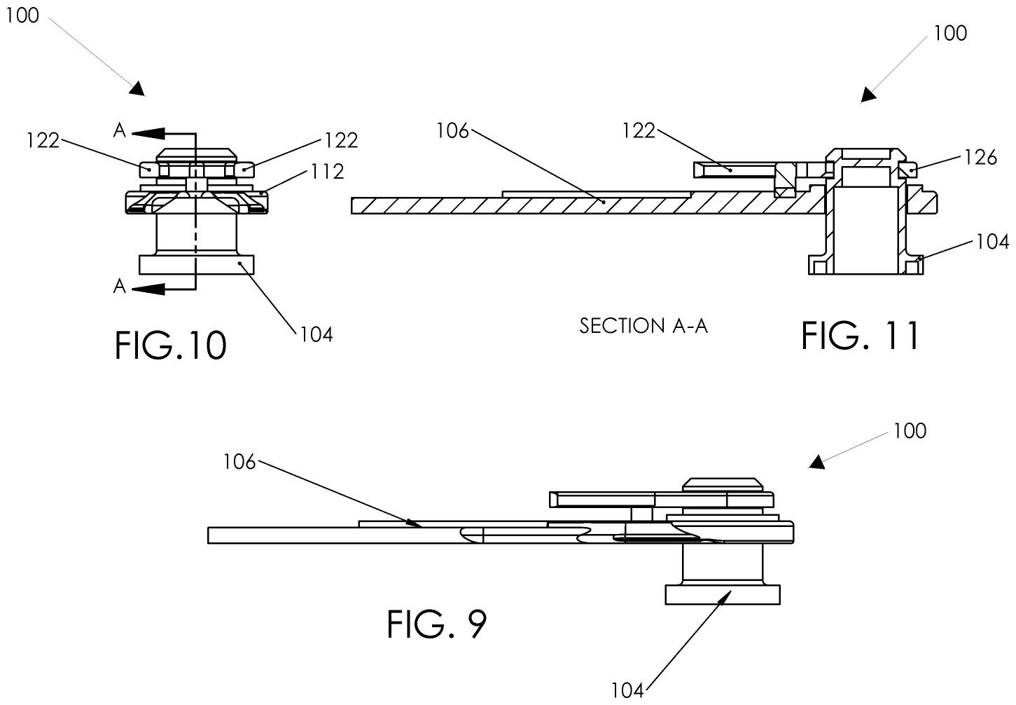

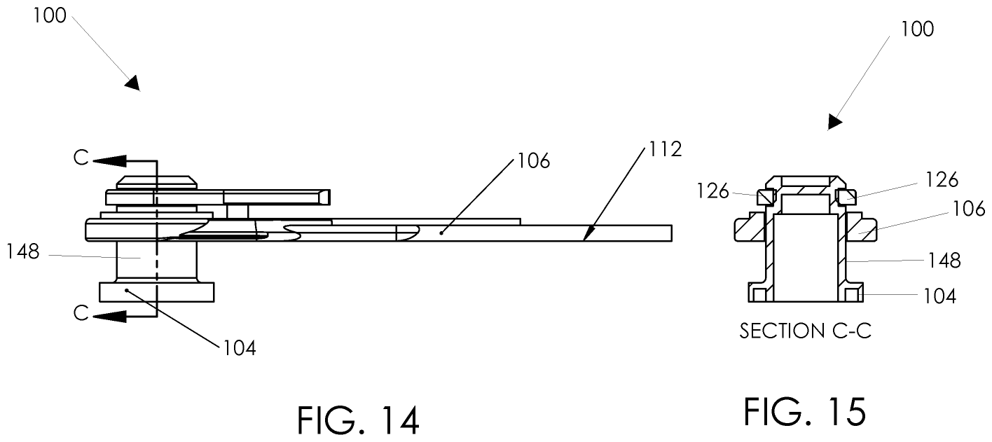

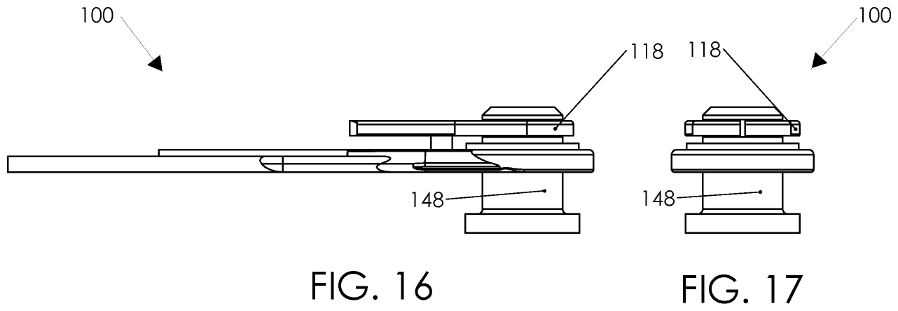

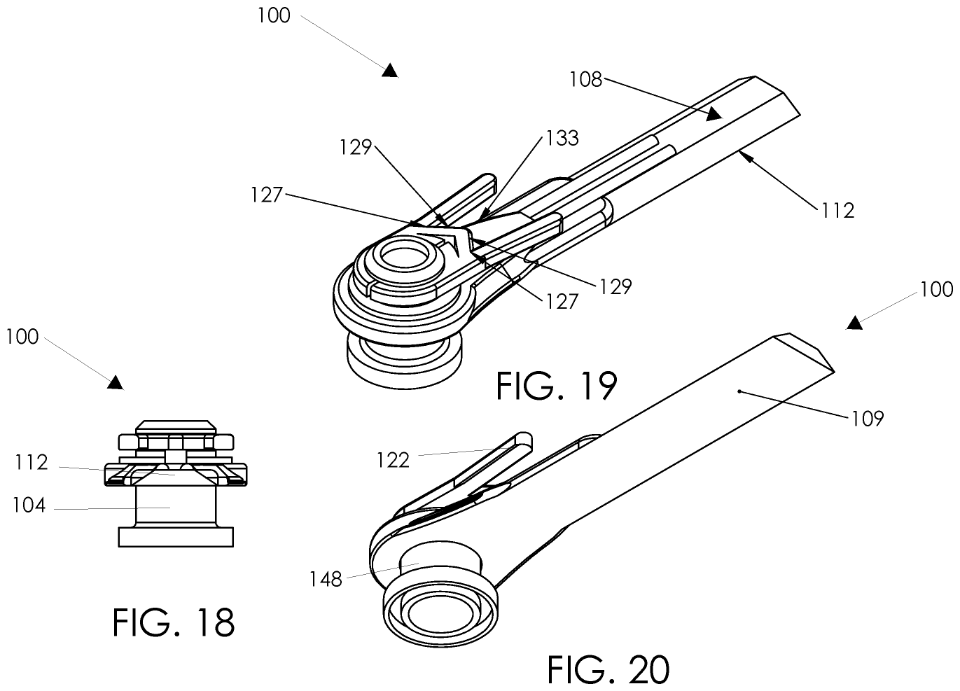

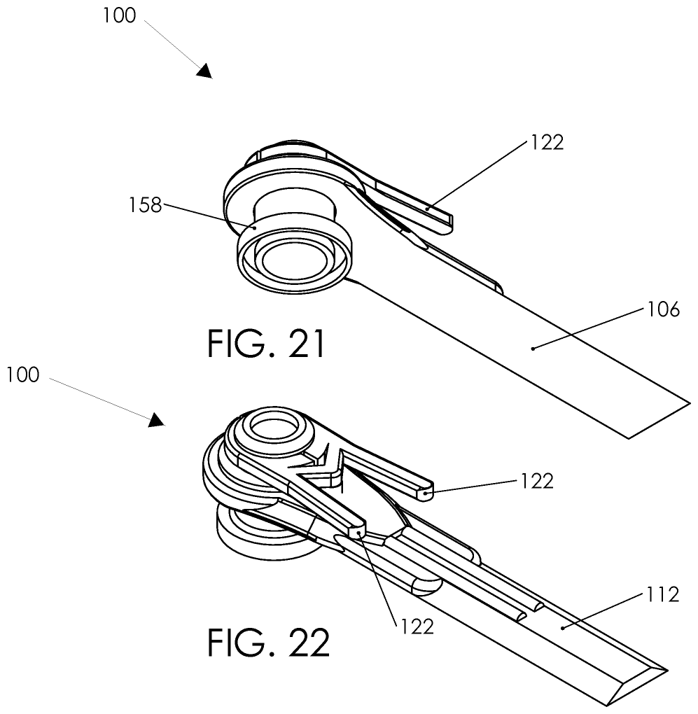

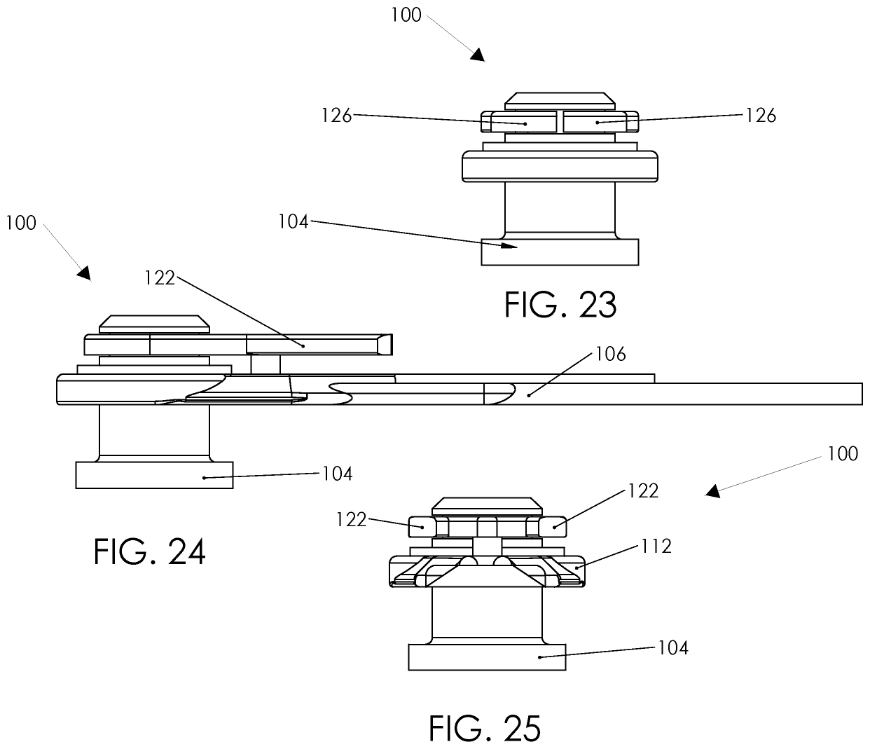

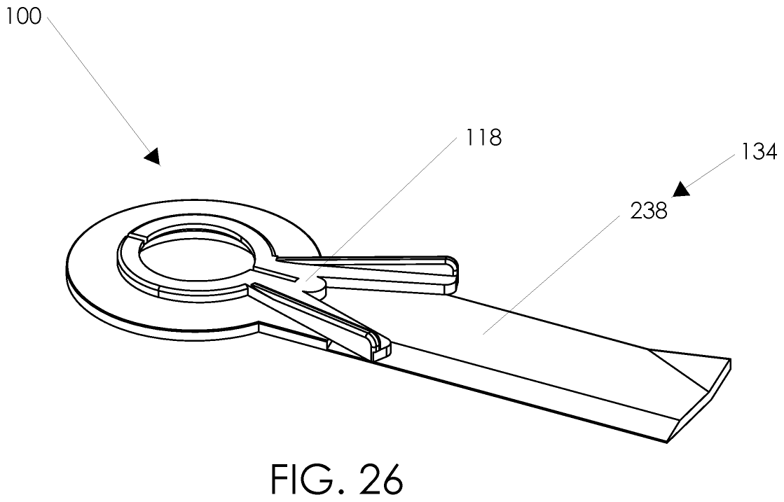

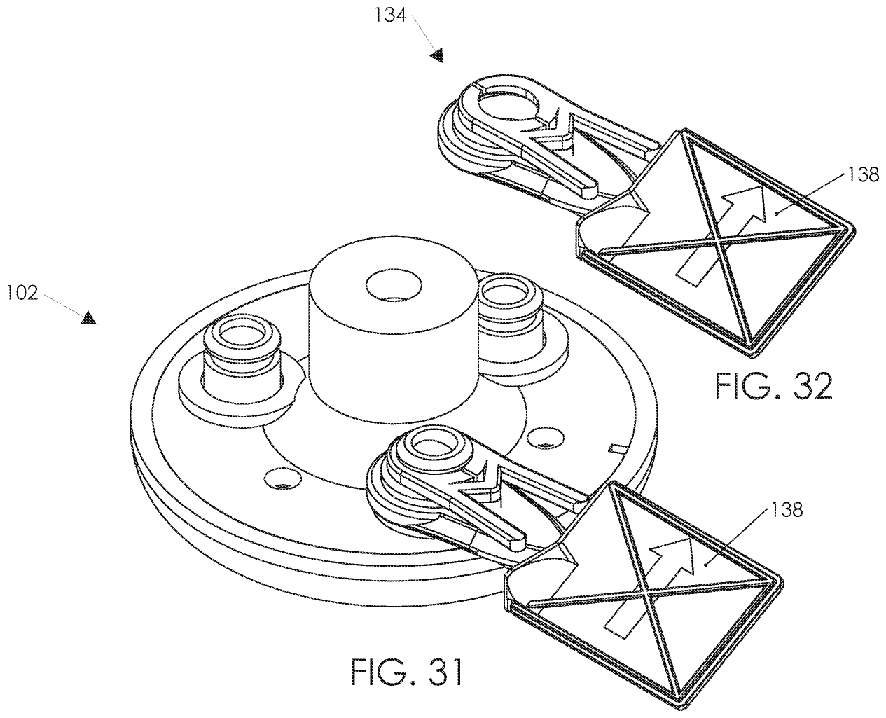

Referring to FIGS. 1-36, in accordance with embodiments of the invention illustrating a cutting blade 100 for use with a rotary trimmer head assembly 102 configured with one or more swiveling blade receptacles 104, as shown in FIG. 1. In FIGS. 2-5 and 9-24, the blade 100 preferably has an elongated body 106 extending along a longitudinal axis. The body 106 forms two opposing planar surfaces 108 and 109, as shown in FIGS. 2-5 and 19-20. The body 106 preferably has a trimmer head connecting end portion 110 and a cutting end portion 112, as illustrated in FIGS. 2-4. As illustrated in FIGS. 2-5, the connecting end portion 110 defines a blade mount aperture 114 adapted to receive the swiveling blade receptacle 104 and the cutting end portion 112 forms at least one cutting edge 116. In such preferred embodiment, as illustrated in FIGS. 2-4 and 6A-8, the connecting end portion 110 preferably includes a spring collar assembly 118 sized and configured to firmly and removably receive and secure a portion of an outer cylindrical surface 120 of the swiveling blade receptacle 104. FIGS. 10 and 11 illustrate the cutting blade 100 and spring collar assembly 118 secured to the outer cylindrical surface 120 of the swiveling blade receptacle 104, from the front and along section A-A. Preferably, the spring collar assembly 118 has a pair of opposing levers 122, each having two ends, 123 and 125, as illustrated in FIGS. 6-8. Each lever 122 preferably has a handle 124 toward ends 123 and a curved jaw 126 toward the ends 125. The curved jaws 126 define a collar aperture 128 in alignment with the blade mount aperture 114, as illustrated in FIGS. 3-5. The levers 122 have a pivotal abutment 130 intermediate the two ends 123 of the levers 122, as illustrated in FIGS. 6-8. Squeezing together the handles 124 of the levers 122 applying an expanding force, as represented by arrow A and arrow B, increases a diameter of the collar aperture 128, as illustrated in FIG. 6B. By increasing the diameter, by squeezing the handles 124, as represented by arrow A and arrow B, of the collar aperture 128 the cutting blade 100 fits over the diameter of the swiveling blade receptacles 104, and by releasing the handles 124 of the levers 122 the diameter of the collar aperture 128 decreases and thereby sits securely within a channel 156. FIG. 15, which is a cross section along section C-C of FIG. 14, illustrates the curved jaws 126 and collar aperture 128 secured within the channel 156.

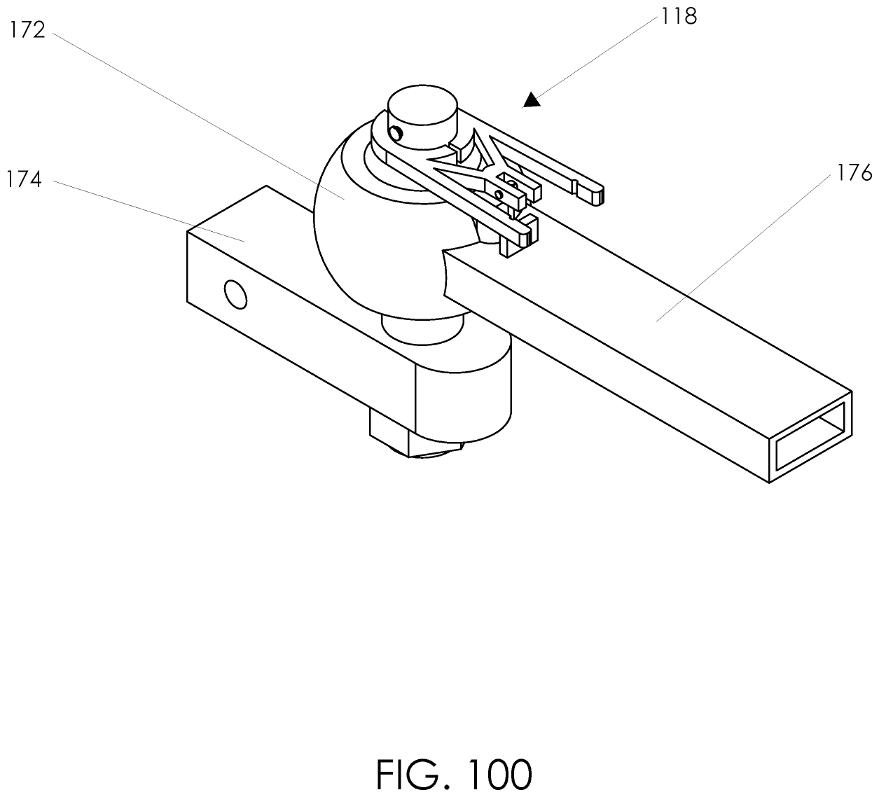

In one embodiment, the spring collar assembly 118 is adapted to connect to a trailer hitch ball 172 of a truck or automobile, so as to removably connect a trailer 174 to the trailer hitch ball 172, when the spring collar assembly 118 is connected to an end of a tongue 176 of a cargo trailer 174 or of a boat trailer 174 or the like, as illustrated in FIG. 100. In such embodiment, the spring collar assembly 118 is sized and configured to firmly and removably receive and secure at least a portion of the trailer hitch ball 172.

In another embodiment, the cutting end portion 112 of the cutting blade 100 forms two opposed cutting edges 116, as illustrated by FIG. 1.

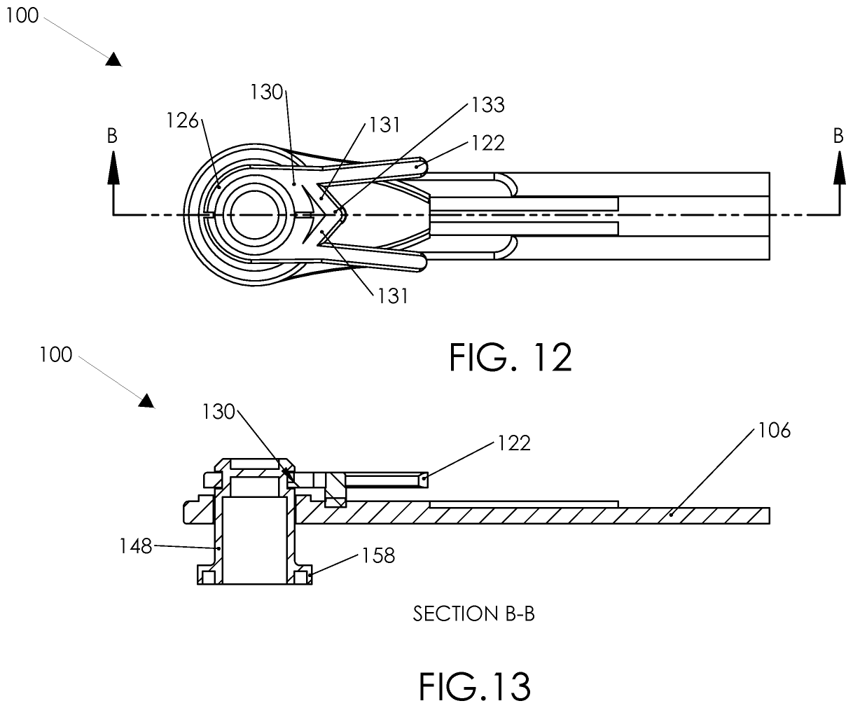

Referring again to FIGS. 1-36, another preferred embodiment of the invention is depicted, a spring collar locking assembly 132 for use with a rotary trimmer head assembly 102 configured with one or more swiveling receptacles 104 is provided. In such preferred embodiment, the spring collar locking assembly 132 has a planar body member 106 defining a blade mount aperture 114 adapted to receive the swiveling blade receptacle 104, as illustrated in FIGS. 1, 27, 29, 31, 33, and 35. The planar body 106 is adapted to receive one or more tool members 134, as illustrated in FIGS. 2, 26, 28, 30, 32, 34, and 36. A pair of opposing levers 122 is preferably mounted to the planar body 106, as illustrated in FIGS. 12-13, whereby the cross section FIG. 13 along section B-B of FIG. 12 illustrates the levers 122 mounted to the planar body 106. As illustrated in FIGS. 6-8, each lever 122 has two ends 123 and 125. Each lever 122 has a respective handle 124 toward the end 123. Each lever 122 has a curved jaw 126 toward the end 125. The curved jaws 126 preferably define a collar aperture 128 in alignment with the blade mount aperture 114, as shown in FIGS. 19-22. As illustrated in FIGS. 3-4, 6-9, and 24, the levers 122 have a pivotal abutment 130 intermediate the two ends 123 of the levers 122. Squeezing together the handles 124 of the levers 122 increases a diameter of the collar aperture 128.

In one embodiment, the pivotal abutment 130 has two radially extending arms 131 at a vertex 133 forming a V-shape, as illustrated in FIGS. 12-13. The radially extending arms 131 have a distal portion 127 opposite a proximate portion 129. Each proximate portion 129 of the two radially extending arms 131 meet at the vertex 133, as illustrated in FIG. 19.

In one embodiment, FIGS. 1 and 2, illustrates the tool member 134 as a cutting blade 100.

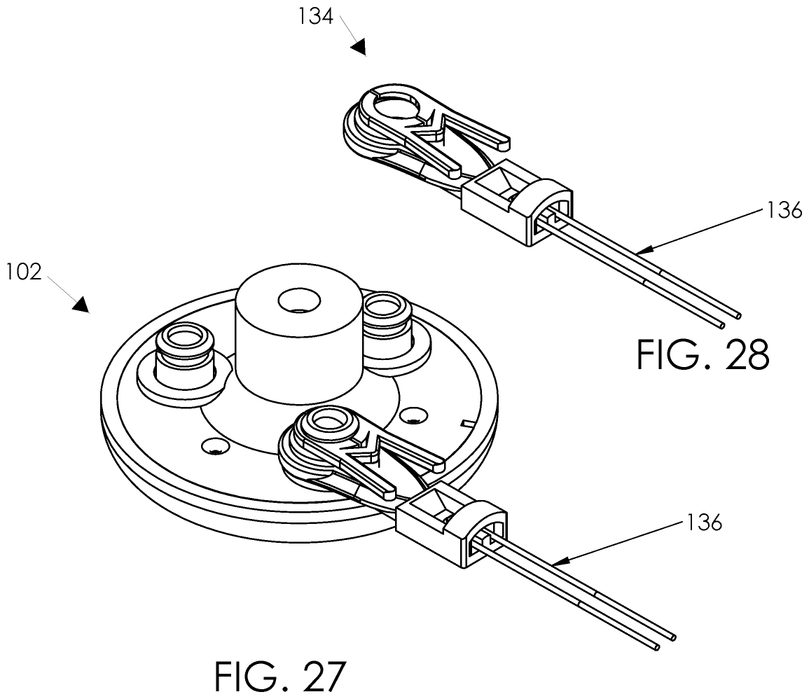

Referring to the embodiment illustrated in FIGS. 27 and 28, the tool member 134 is a trimmer line 136. For example, the tool member 134 is adapted to accommodate exemplary commercially available trimmer lines 136 such as flexible monofilament plastic trimmer lines of any suitable type and cross-sectional configuration, e.g., 0.065, 0.080, 0.095, 0.105, 0.12, 0.13 or 0.15 gauge nylon trimmer line or the like.

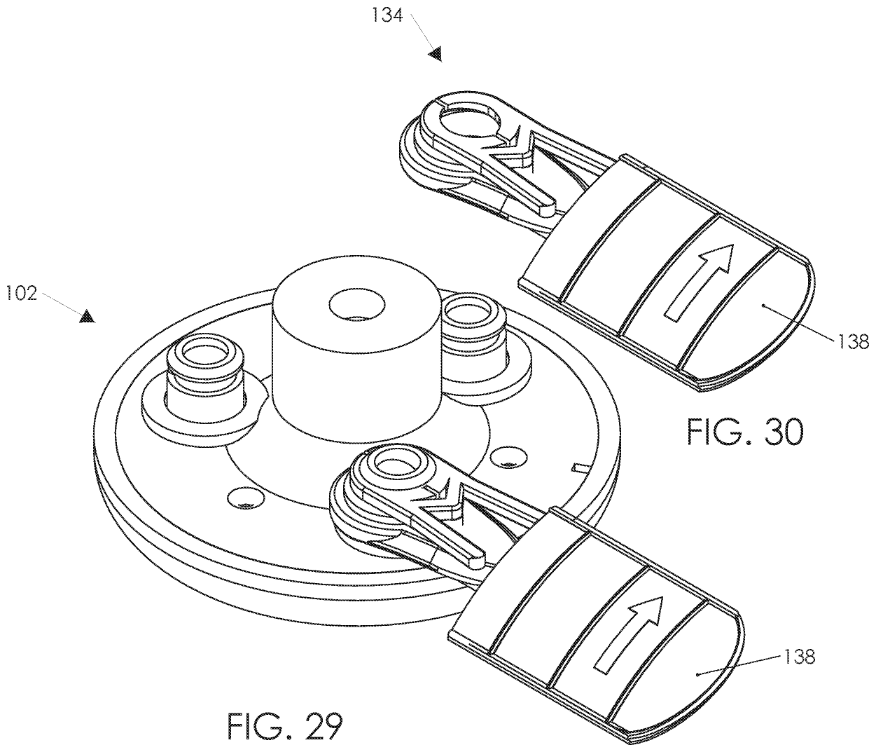

In yet another embodiment, the tool member 134 is a blower blade 138, as shown in FIGS. 29-32.

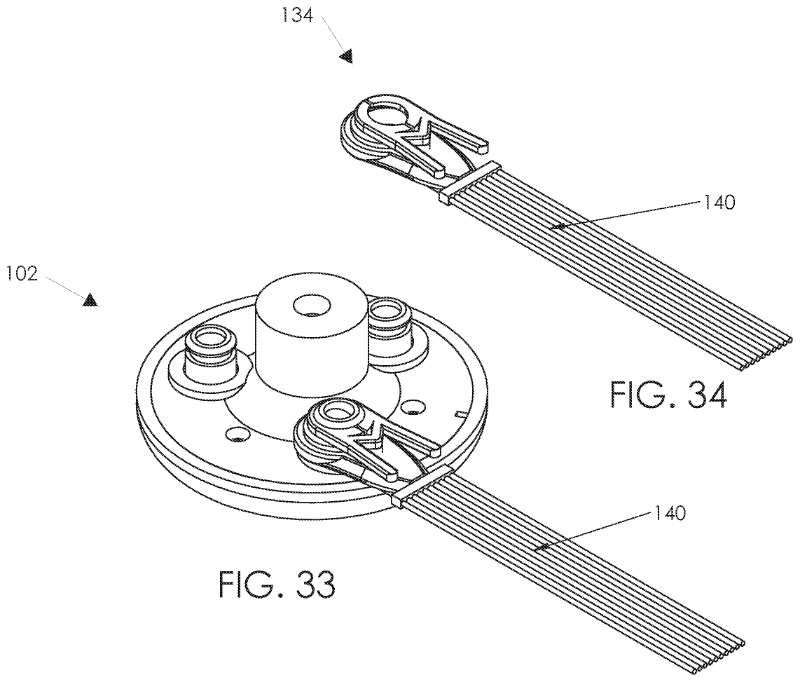

Referring to the embodiment illustrated in FIGS. 33 and 34, the tool member 134 is a broom 140.

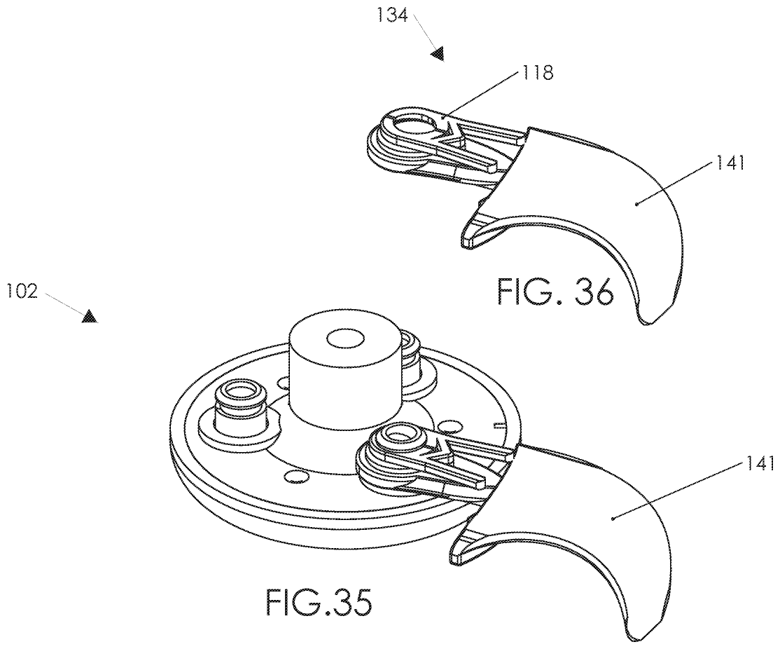

Referring to the embodiment illustrated in FIGS. 35 and 36, the tool member 134 is a propeller 141. Wherein the propeller 141 is adapted to propel a boat.

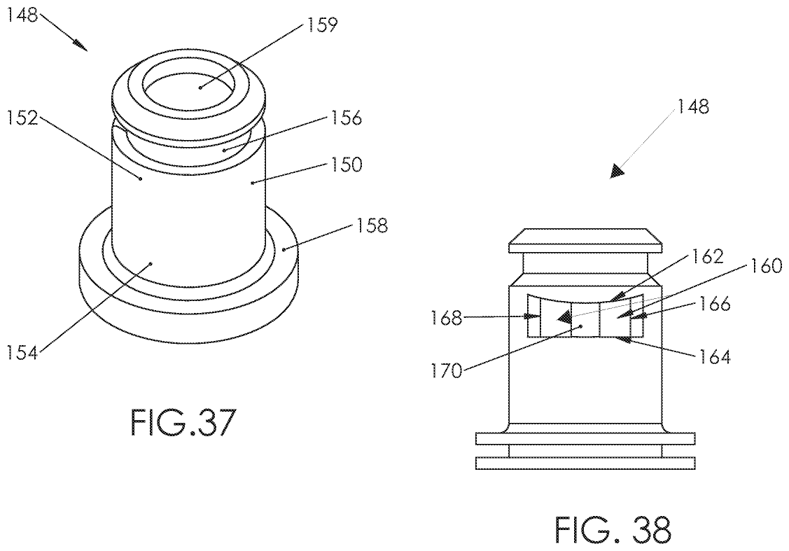

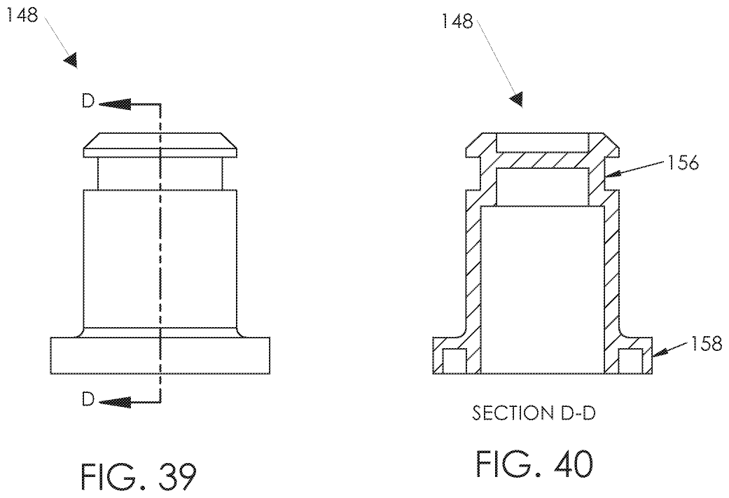

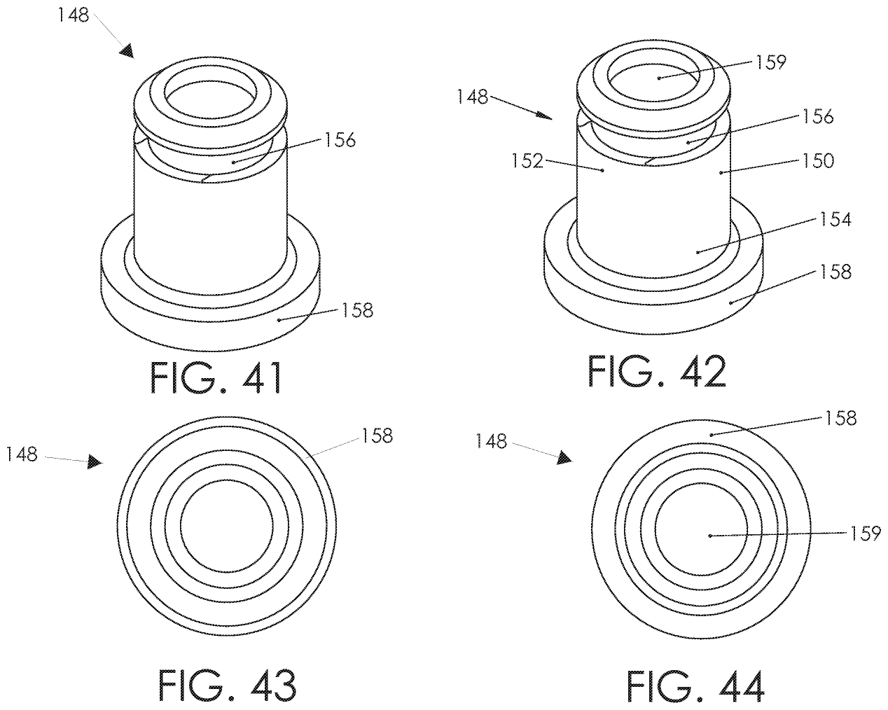

In accordance with embodiments of the invention, FIGS. 37-44 illustrate a trimmer member receptacle 148 configured for use with a rotary trimmer head assembly 102 having a cylindrical body 150. The cylindrical body 150 preferably has an upper portion 152 opposite a lower portion 154, as illustrated in FIGS. 37-42. The upper portion 152 defines a channel 156 adapted to receive a spring collar locking assembly 132, as illustrated in FIGS. 37-42. FIG. 40 illustrates the channel 156 along the section D-D of FIG. 39 which is adapted to receive a spring collar locking assembly 132. The lower portion 154 preferably has a cylindrical flange 158 configured for attachment to the rotary trimmer head assembly 102. In one embodiment, a depression 159 is defined by the upper portion 152 of the cylindrical body 150, as illustrated in FIGS. 42 and 44.

In one embodiment, as illustrated in FIG. 38, the cylindrical body 150 defines a passage 160 therethrough. The passage 160 is defined by a top wall 162, a bottom wall 164 and a pair of opposing side walls 166 and 168 connecting the top wall 162 and bottom wall 164.

In one embodiment, a tongue 170 is disposed within the passage 160 as illustrated in FIG. 38.

In another embodiment, the trimmer member receptacle 148 is fixed to the rotary trimmer head assembly 102.

In yet another embodiment, the trimmer member receptacle 148 is dynamically connected to the rotary trimmer head assembly 102.

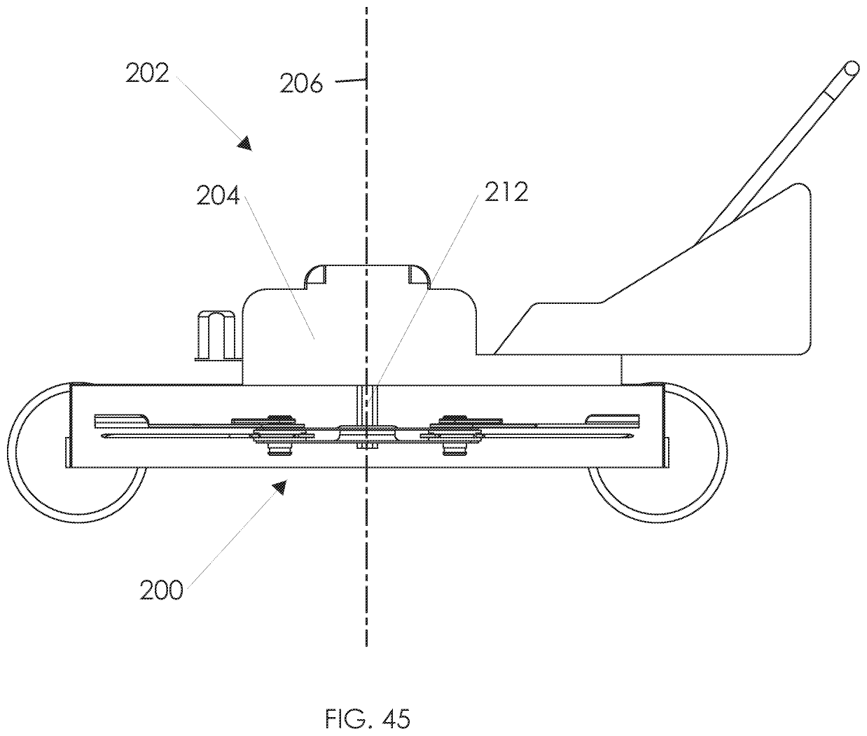

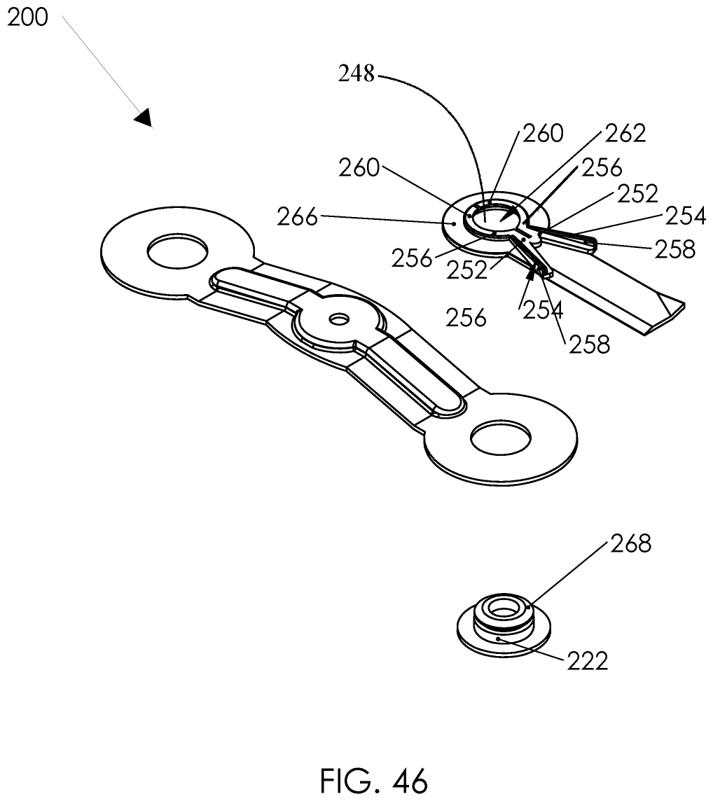

Referring to FIGS. 45-49E, embodiments of the invention illustrate a lawn mower blade assembly 200 for use with a rotary lawn mower 202 configured with a motor 204 rotating horizontally around a vertical axis 206. Referring initially to FIGS. 46-48, the lawn mower blade assembly 200 preferably includes a rotatable planar body 208 defining a centrally disposed drive mount opening 210 configured for receiving a mower motor drive shaft 212. The planar body 208 preferably has two or more elongated arms 214 extending outwardly therefrom, each arm having a proximal end 216 opposite a distal end 218. The distal end 218 of each arm 214 defines a receptacle aperture 220 configured to receive a swiveling blade receptacle 222 therethrough.

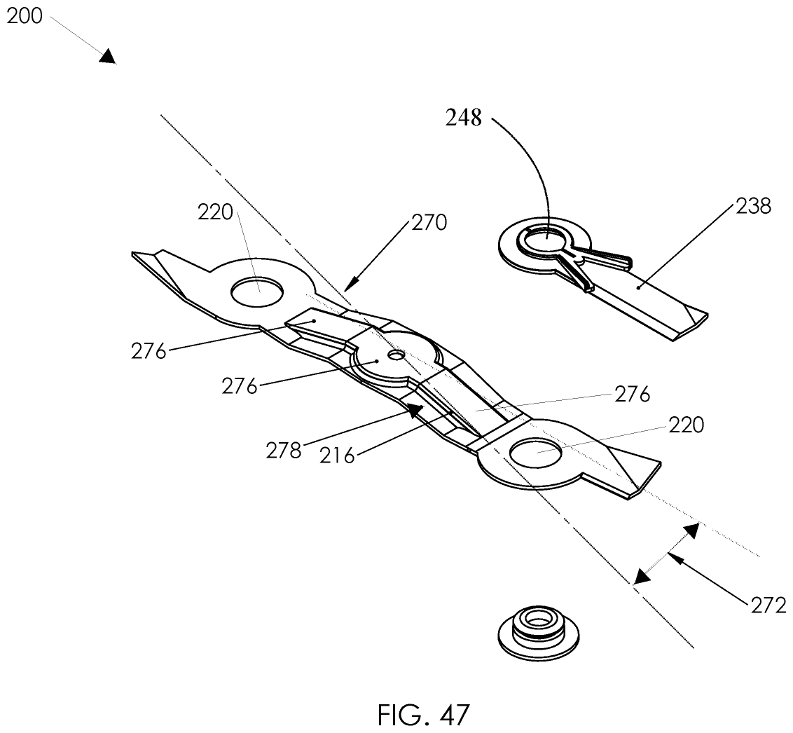

Preferably, the lawn mower blade assembly 200 includes at least one swiveling blade receptacle 222 having a cylindrical body 224 configured to be removably inserted through the receptacle aperture 220. As can be seen in FIG. 47, the swiveling receptacle 222 is freely spinnable within the receptacle aperture 220. The swiveling receptacle 222 is removably attachable to the elongated arm 214.

In another embodiment, the receptacle is a fixed blade receptacle 234 for a swiveling blade 238. Preferably, the fixed blade receptacle 234 is manufactured as an integral component of the elongated arm 214.

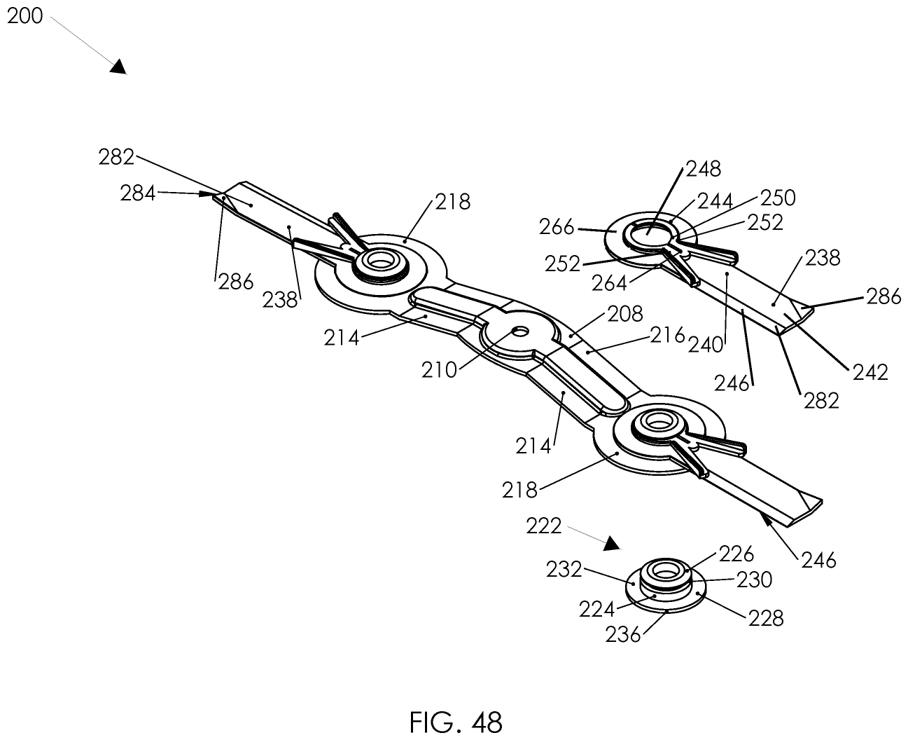

Preferably, the at least one swiveling blade receptacle 222 has a cylindrical body 224 having an upper portion 226 opposite a lower portion 228. The upper portion 226 defines an annular ring channel 230 or groove along the periphery of the upper portion 226 of the cylindrical body 224. Preferably, the annular ring channel 230 is adapted to receive a spring collar locking assembly 250, as illustrated in FIG. 46. The lower portion 228 includes a cylindrical flange 232 extending radially outwardly from the body 224. As can be seen in FIG. 48, the flange 232 is preferably positioned around the perimeter of a bottom edge 236 of the lower portion 228 of the cylindrical body 224 of the swiveling blade receptacle 222. The flange 232 is preferably configured to restrain the swiveling blade receptacle 222 from moving through the receptacle aperture 220.

As illustrated in FIGS. 46-49E, the lawn mower blade assembly 200 preferably includes a cutting blade 238 having an elongated body 240. The elongated body 240 has a cutting end portion 242 and a connecting end portion 244. The cutting end portion 242 forms at least one cutting edge 246. As shown in FIG. 46, the connecting end portion 244 defines a blade mount aperture 248 adapted to receive the swiveling blade receptacle 222. The connecting end portion 244 includes a spring collar assembly 250 having a pair of opposing levers 252 having two ends 254 and 256. Preferably, each lever 252 has a handle 258 toward one of the ends 254 and a curved jaw 260 toward the other end 256. The curved jaws 260 define a collar aperture 262 in coaxial alignment with the blade mount aperture 248. Preferably, the levers 252 have a pivotal abutment 264 intermediate the two ends of the levers 252 and squeezing together the handles 258 of the levers 252 increases a diameter of the collar aperture 262. The jaws 260 which form the collar aperture 262 are preferably sized and configured to firmly and removably engage the annular ring channel 230 of the upper portion 226 of the swiveling blade receptacle 222 to removably connect the blade 238 to the swiveling blade receptacle 222, such as, to secure the blade 238 against vertical movement relative to the receptacle 222, as shown in FIG. 47.

In a preferred embodiment, the cutting blade 238 is secured to the rotatable planar body 208 of the lawn mower blade assembly 200 when the curved jaws 260 engage the annular ring 230 of the swiveling blade receptacle 222. As can be seen in FIG. 46, preferably, the collar aperture 262 formed by the jaws is coaxially aligned concentric with the receptacle aperture 220, such that the swiveling blade receptacle 222 extends therethrough in coaxial alignment with both the receptacle aperture 220 and the collar aperture 262. As can be seen in FIG. 47, the mount aperture 248 of the blade 238 surrounds the swiveling blade receptacle 222 and retains the blade 238 against centrifugal forces exerted by the spinning of the planar body 208 when driven by the motor 204 and drive shaft 212 during operation of the lawn mower 202.

In one embodiment, the connecting end portion 244 of the cutting blade 238 forms a washer 266, and the washer 266 forms the blade mount aperture 248, as shown in FIG. 46.

In a preferred embodiment, shown in FIG. 47, the swiveling blade receptacle 222 is freely spinnable within the receptacle aperture 220 and coaxially aligned concentric with the receptacle aperture 220.

In yet another embodiment, a top end 268 of the upper portion 226 of the swiveling blade receptacle 222 is beveled, illustrated in FIG. 46.

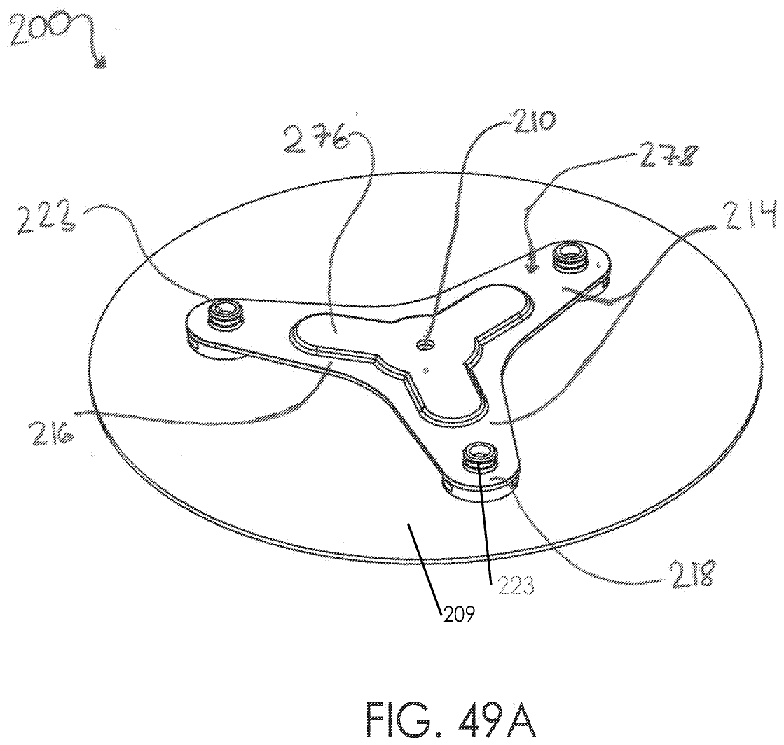

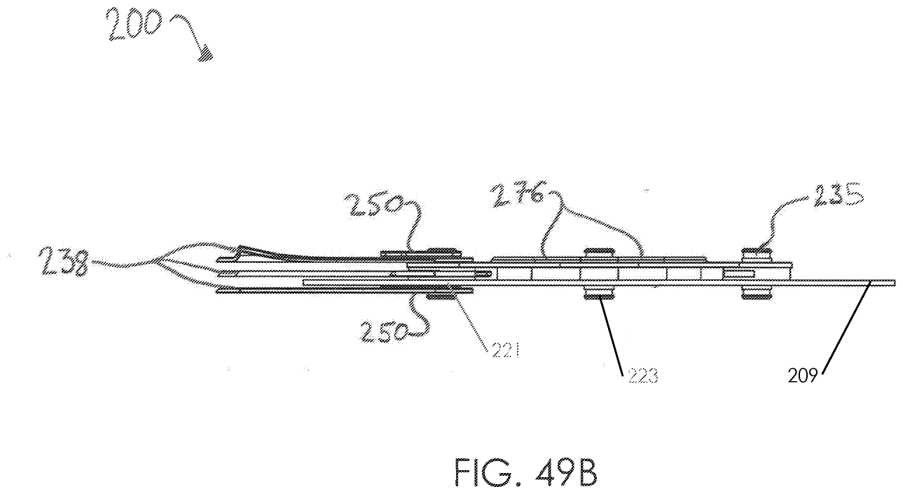

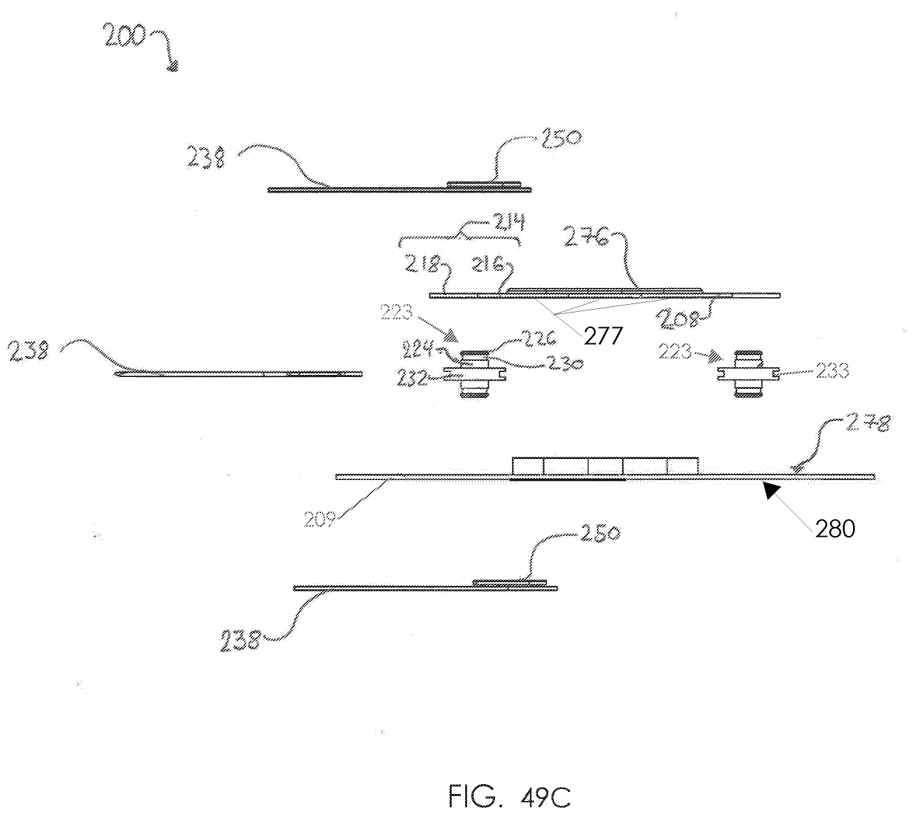

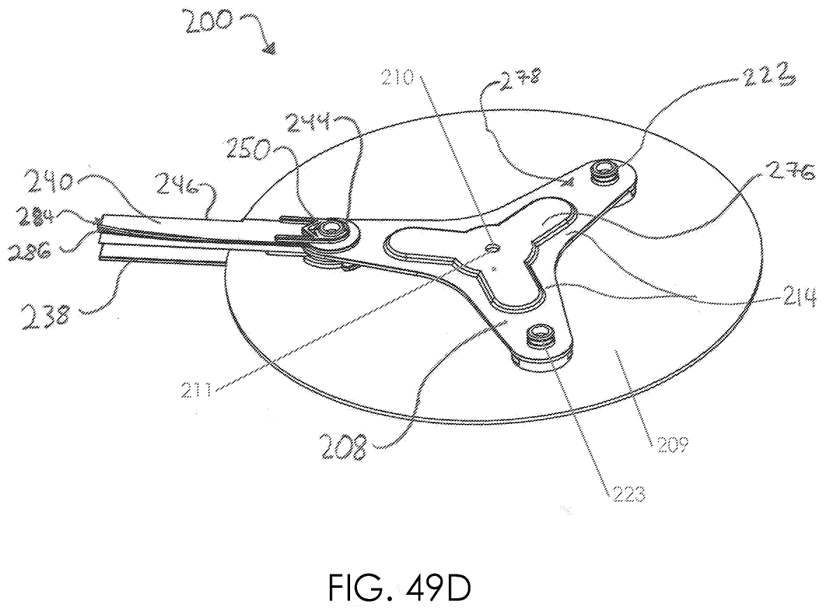

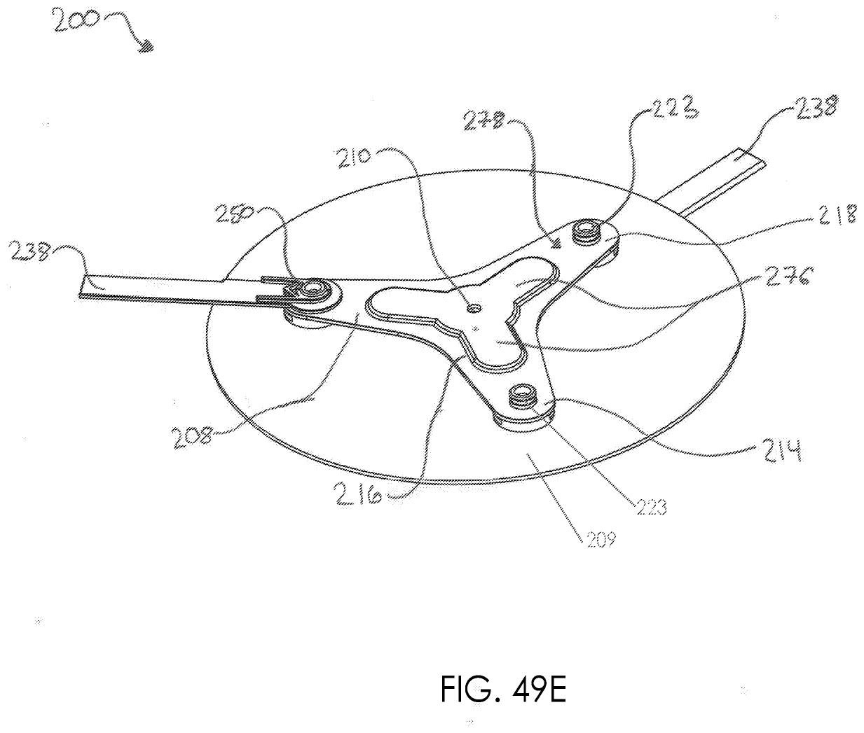

As illustrated in FIGS. 49A-49E, in one embodiment, the rotatable planar body 208 has three radially extending arms 214, and each arm 214 defines a receptacle aperture 220 configured to receive a swiveling blade receptacle 222 therethrough. Preferably, each radially extending arm 214 is spaced apart equally for balance, as illustrated in FIGS. 49A-49E.

Referring to FIGS. 49A-49E, the lawn mower blade assembly 200 preferably includes a rotatable planar body 208 defining a centrally disposed drive mount opening 210 configured for receiving a mower motor drive shaft 212, and the lawn mower blade assembly 200 includes a second planar body, preferably in the form of a planar disc 209, defining a centrally disposed drive mount opening 211 configured for receiving a mower motor drive shaft 212. As seen in FIGS. 49A and 49B, the planar disc 209 is configured in coaxial alignment with the rotatable planar body 208. As such, the drive mount opening 211 of the planar disc 209 is in coaxial alignment with the drive mount opening 210 of the planar body 208. In such illustrated embodiment, the planar body 208 preferably has three or more elongated arms 214 extending outwardly therefrom.

As seen in FIGS. 49A and 49B, the receptacle aperture 220 of each arm preferably coaxially aligns with the receptacle aperture 221 of the planar disc 209, such that the double ended swiveling blade receptacle 223 extends through the receptacle aperture 220 of one arm and also extends through the receptacle aperture 221 of the planar disc 209.

FIG. 49D illustrates an exemplary double ended swiveling blade receptacle 223 disposed within an exemplary lawn mower blade assembly 200, and FIGS. 49B and 49D illustrates, for example, that three blades 238 are operatively connected to the double ended swiveling blade receptacle 223, in accordance with embodiments of the invention. As illustrated, a single blade 238 can be installed by connection to the bottom portion of the double ended swiveling blade receptacle 223; or alternatively, a single blade 238 can be installed by connection to the middle portion of the double ended swiveling blade receptacle 223; or alternatively, a single blade 238 can be installed by connection to the top portion of the double ended swiveling blade receptacle 223. Accordingly, a single blade 238 can be easily installed at one of three different heights, at the option of the user, where each respective installation height lends itself to a respective cutting height of the trimmer blade 238 during operation of the lawn mower blade assembly 200. When one, two and/or three blades 238 are installed by connection to the double ended swiveling blade receptacle 223, each of those blades 238 can rotate 360 degrees, pivoting in an oscillating manner around the double ended swiveling blade receptacle 223 to which each is respectively operatively connected. As such, when a blade 238 strikes a hard object during operation of the lawn mower blade assembly 200, the blade 238 is pivoted or rotated inwardly, relative to the drift shaft, whereby the disc 209 protects the blade 238 from further obstruction by such hard object, because the disc 209 serves as a protective barrier between the hard object and the then inwardly rotated blade 238; and hence, the disc 209 mitigates or obviates damage to the blade 238 from the hard object. Such blade is then rotated back outwardly as a result of centrifugal forces exerted by the spinning of the lawn mower blade assembly 200 by the drive shaft of the mower. As can be seen, the double ended swiveling blade receptacle 223 has a top portion similar to swiveling blade receptacle 222 and has a bottom portion similar to an upside-down (or mirror imaged) swiveling blade receptacle 222, each having an annular ring channel 230, and the double ended swiveling blade receptacle 223 has a middle flange portion 232 disposed between the top portion and bottom portion. Preferably, the middle flange portion 232 of the double ended swiveling blade receptacle 223 defines a passageway 233 for the insertion of an elongated blade member, which preferably has one or more laterally extending arms at its connected end which are arcuate in shape and preferably shaped to engage and secure to at least a portion of the outer surface of the middle flange portion 232 after insertion of the cutting portion of the blade through the passageway 233.

As illustrated in FIG. 49B, the exemplary lawn mower blade assembly 200 includes at least one double ended swiveling blade receptacle 223, as illustrated, for example, on the left-hand side of the assembly in FIG. 49B. In a preferred embodiment, as illustrated in FIGS. 49A, 49C, 49D, and 49E, the exemplary lawn mower blade assembly 200 includes at least two, and more preferably at least three or more, double ended swiveling blade receptacles 223 that are spaced apart evenly, relative to the drive shaft, for balance during operation.

In another embodiment, the exemplary lawn mower blade assembly includes at least one double ended fixed blade receptacle 235, which can accommodate and retain one or more swiveling cutting blade members which can operatively connect to the double ended fixed blade receptacle 235, as illustrated, for example, on the right-hand side of the assembly in FIG. 49B.

In one embodiment, the rotatable planar body 208 has four radially extending arms 214, each arm 214 defining a receptacle aperture 220 configured to receive a swiveling blade receptacle 222 therethrough, and each arm 214 radially is spaced equally.

In yet another embodiment, as illustrated in FIG. 47, at least one of said two or more elongated arms 214 has a longitudinal axis 270 that departs at an acute angle 272 relative to the planar body 208. The distal end 218 of the at least one of said two or more elongated arms 214 has a horizontal plane 274 parallel to the planar body 208.

In one embodiment, the lawn mower blade assembly 200 includes an elongated batten 276 disposed along at least a top 278 or bottom surface 280 of the rotatable planar body 208 and two or more elongated extending arms 214.

As illustrated in FIG. 48, in another embodiment, the lawn mower blade assembly 200 includes an elongated batten 276 formed along a top surface 278 of the rotatable planar body 208 and two or more elongated extending arms 214. In such embodiment, the batten 276 defines a channel 277 along a bottom surface 280 of the rotatable planar body 208 and two or more elongated extending arms 214.

In another embodiment, the cutting end portion 242 forms two opposed cutting edges 246.

In yet another embodiment, cutting end portion 242 of the cutting blade 238 has a tip 282 at the end thereof, as shown in FIGS. 46-48. The tip 282 has a corner 284 opposite to the at least one cutting edge 246 and the corner 284 is tilted upwardly to define a sail 286. In one embodiment, the sail 286 has a face 288 inclined inwardly at the end of the cutting blade 238.

When the lawn mower blade assembly 200 is rotating at normal speed, the cutting blades 238 are swung outwardly by centrifugal force and swing on the swiveling blade receptacles 222 outwardly, as shown in FIGS. 45 and 47. The cutting edges 246 of cutting blades 238 then slice through the grass or stems to be cut, thus mowing the same in a simple and efficient manner. If one of the cutting blades 238 strikes a hard to cut stem, the first blade striking it may be moved inwardly over the distal end 218 of the elongated arm 214 and the following blade or blades giving the stem one or more additional whacks until the stem is severed. As soon as the cutting blades 238 pass the stem being cut, the cutting blades 238 fly outwardly by centrifugal force and act on the grass or stems in their path. If a stone or other object incapable of being cut is engaged by the cutting blade 238, the cutting blade 238 is forced inwardly over the distal end 218 of the elongated arm 214 as previously described, and if the object is not removed by the blade, then it is removed by engagement with the cutting edge 246 of the following cutting blade 238.

Referring to FIGS. 45-49E, in accordance with embodiments of the invention, there is provided an exemplary cutting blade 238 for use with a lawn mower blade assembly 200. The cutting blade 238 includes an elongated body 240 having a cutting end portion 242 and a connecting end portion 244. The cutting end portion 242 forms at least one cutting edge 246. The connecting end portion 244 defines a blade mount aperture 248 adapted to receive a swiveling blade receptacle 222, illustrated in FIG. 46. The connecting end portion 244 has a spring collar assembly 250 including a pair of opposing levers 252 having two ends 254 and 256, each lever 252 having a handle 258 toward one of the ends 254 thereof and a curved jaw 260 toward the other ends 256. The curved jaws 260 define a collar aperture 262 in coaxial alignment with the blade mount aperture 248. The levers 252 have a pivotal abutment 264 intermediate the two ends of the levers 252. Squeezing together the handles 258 of the levers 252 increases a diameter of the collar aperture 262, as illustrated in FIG. 6B. As shown in FIG. 48, the jaws 260 are sized and configured to firmly and removably engage and secure an annular ring channel 230 of an upper portion 226 of a swiveling blade receptacle 222.

In one embodiment, the connecting end portion 244 of the cutting blade 238 forms a washer 266 and the washer 266 forms the blade mount aperture 248, as shown in FIG. 49B.

In another embodiment, the cutting end portion 242 forms two opposed cutting edges 246.

As shown in FIGS. 45-48, in yet another embodiment, cutting end portion 242 of the cutting blade 238 has a tip 282 at the end thereof. The tip 282 has a corner 284 opposite to the at least one cutting edge 246 and the corner 284 is tilted upwardly to define a sail 286. In one embodiment, the sail 286 has a face 288 inclined inwardly at the end of the cutting blade 238.

In accordance with embodiments of the invention, there is provided a cutting blade assembly 288 for use with a rotary lawn mower 202 configured with a motor 204 rotating horizontally around a vertical axis 206, shown in FIG. 45. The cutting blade assembly 288 includes at least one swiveling blade receptacle 222 having a cylindrical body 224 adapted to be removably inserted into a receptacle aperture 220 of a cutting blade 200. The cylindrical body 224 having an upper portion 226 opposite a lower portion 228. The upper portion 226 defines an annular ring channel 230 or groove along the periphery of the upper portion 226 of the cylindrical body 224, as shown in FIG. 48. Preferably, the annular ring channel 230 is adapted to receive a spring collar locking assembly 250. The lower portion 228 includes a cylindrical flange 232 extending radially outwardly from the body 224. As can be seen in FIGS. 46-48, the flange 232 is preferably positioned around the perimeter of a bottom edge 236 of the lower portion 228 of the cylindrical body 224 of the swiveling blade receptacle 222. The flange 232 is preferably configured to restrain the swiveling blade receptacle 222 from moving through the receptacle aperture 220.

As illustrated in FIGS. 46 and 48, the cutting blade assembly 288 preferably includes a cutting blade 238 having an elongated body 240 having a cutting end portion 242 and a connecting end portion 244. The cutting end portion 242 forms at least one cutting edge 246 and the connecting end portion 244 defines a blade mount aperture 248 adapted to receive the swiveling blade receptacle 222. The connecting end portion 244 includes a spring collar assembly 250 having a pair of opposing levers 252 having two ends 254 and 256, each lever 252 having a handle 258 toward one of the ends 254 thereof and a curved jaw 260 toward the other ends 256. The curved jaws 260 define a collar aperture 262 in coaxial alignment with the blade mount aperture 248. Preferably, the levers 252 have a pivotal abutment 264 intermediate the two ends of the levers 252 and squeezing together the handles 258 of the levers 252 increases a diameter of the collar aperture 262. The jaws 260 are sized and configured to firmly and removably engage and secure the annular ring channel 230 of the upper portion of the swiveling blade receptacle 222 and the cutting blade 238 is adapted to be secured to the swiveling blade receptacle 222 in order to connect to, for instance, a rotatable planar body, a rotary cutter head, etc., when the curved jaws 260 engage the annular ring channel 230 of the swiveling blade receptacle 222.

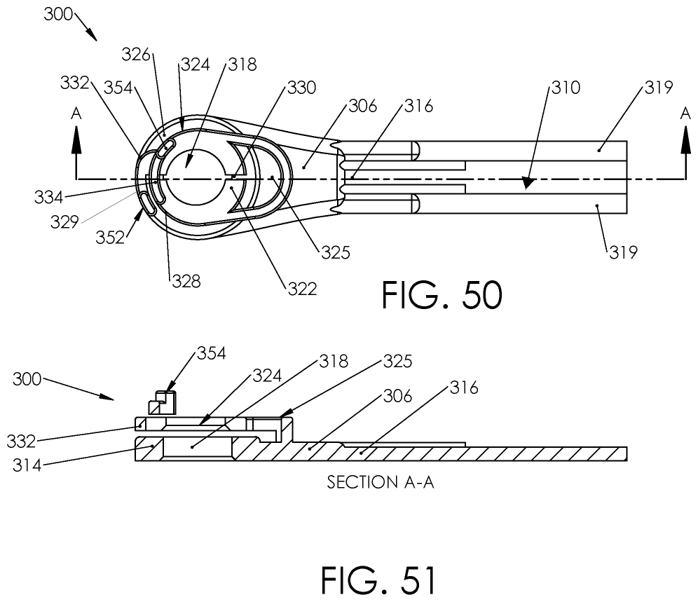

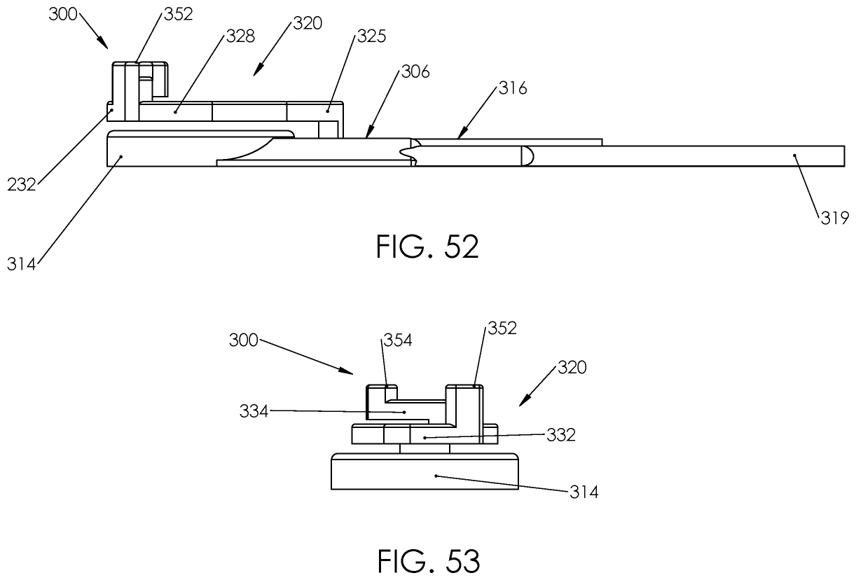

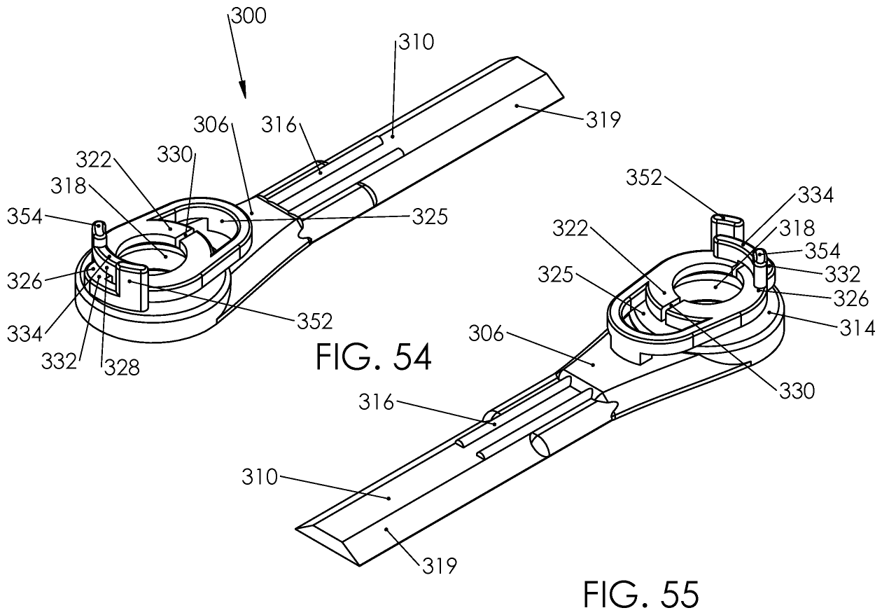

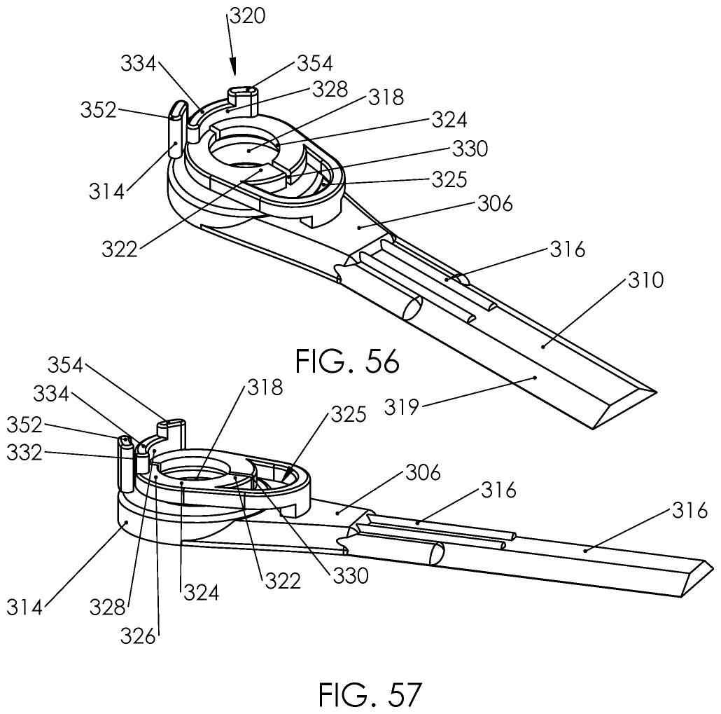

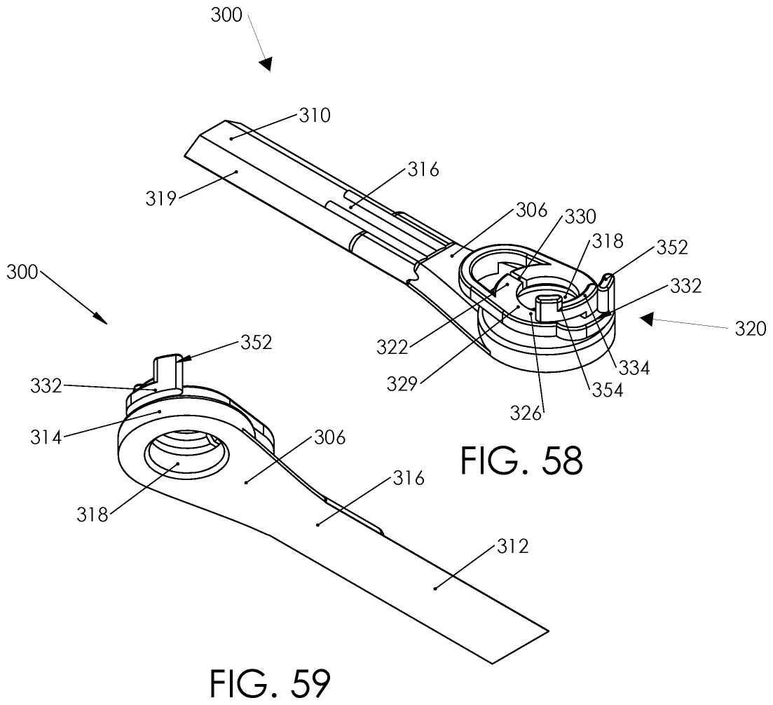

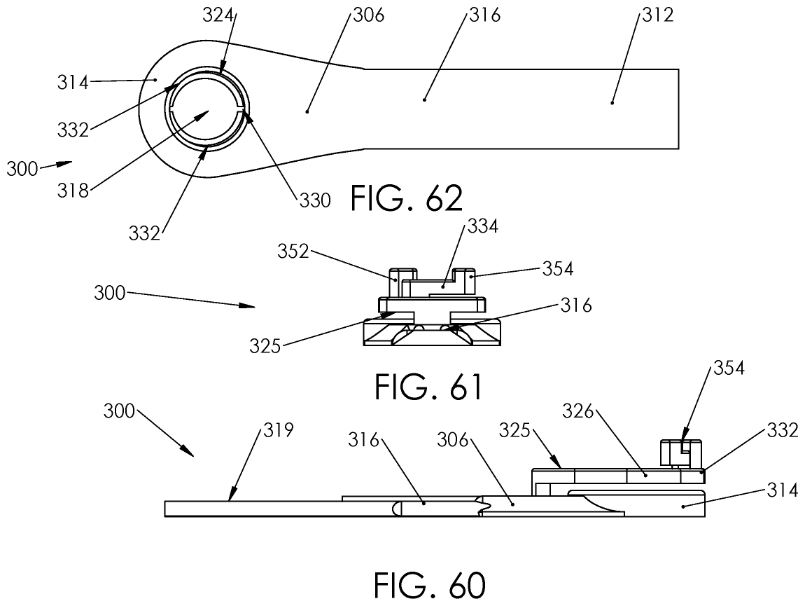

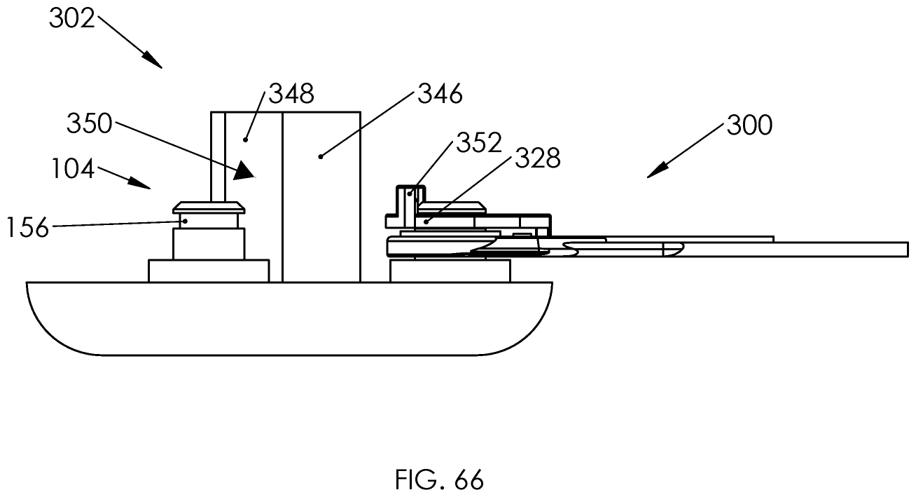

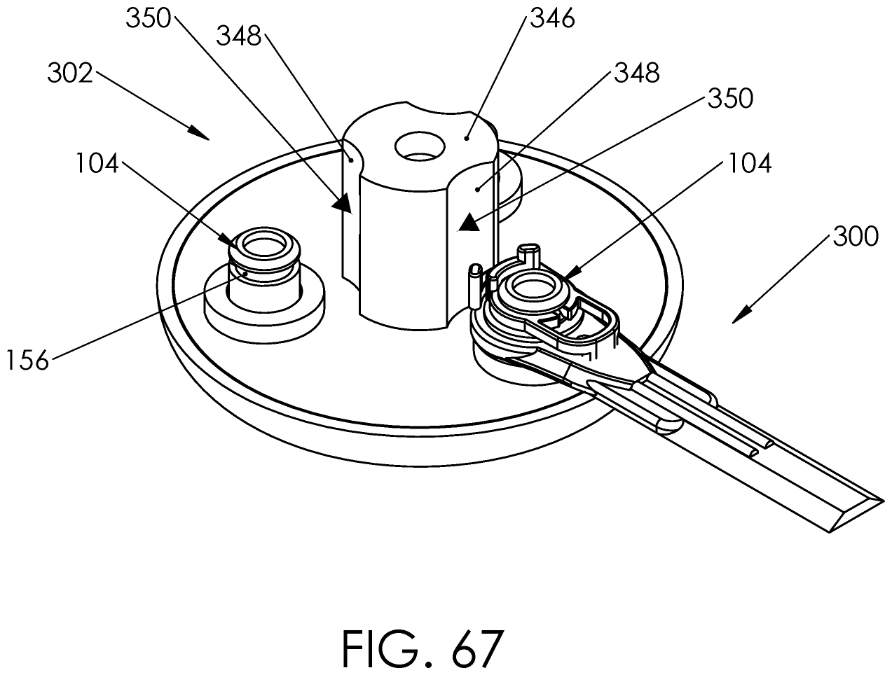

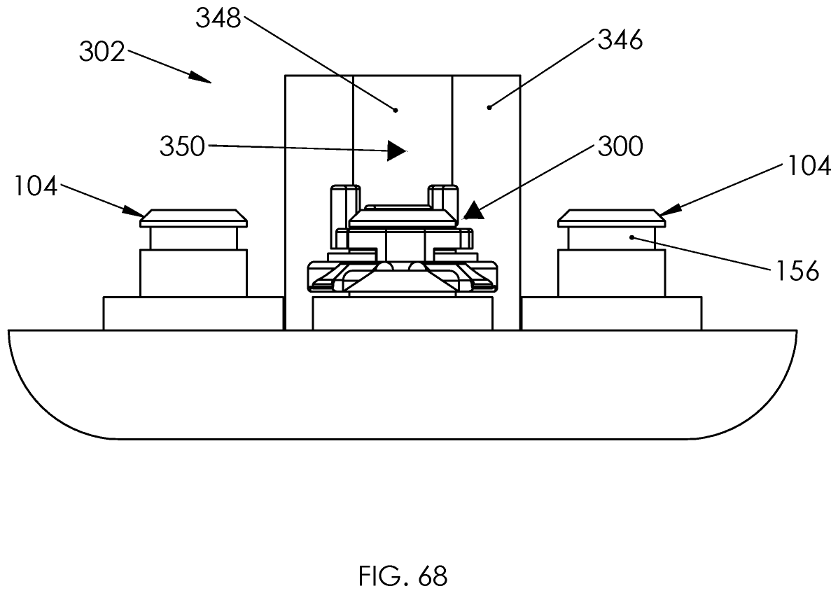

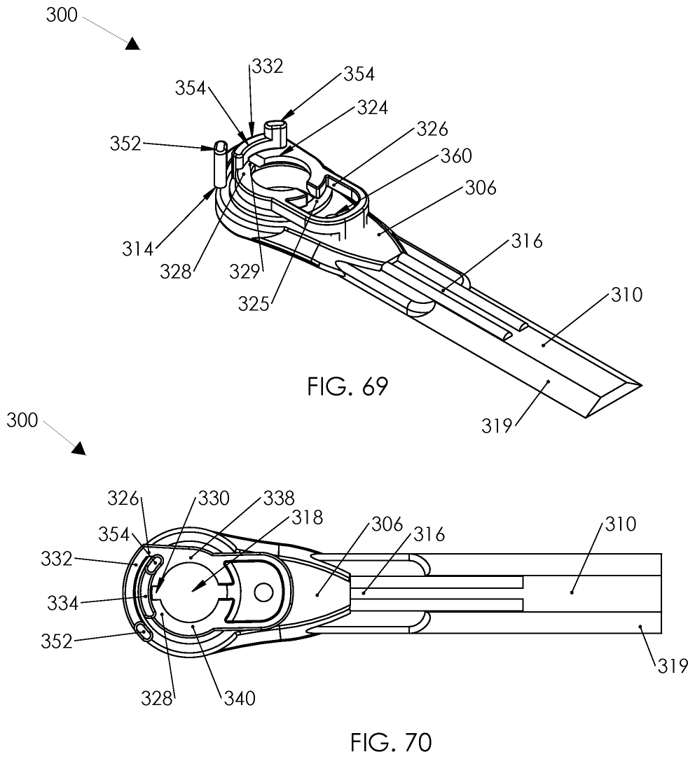

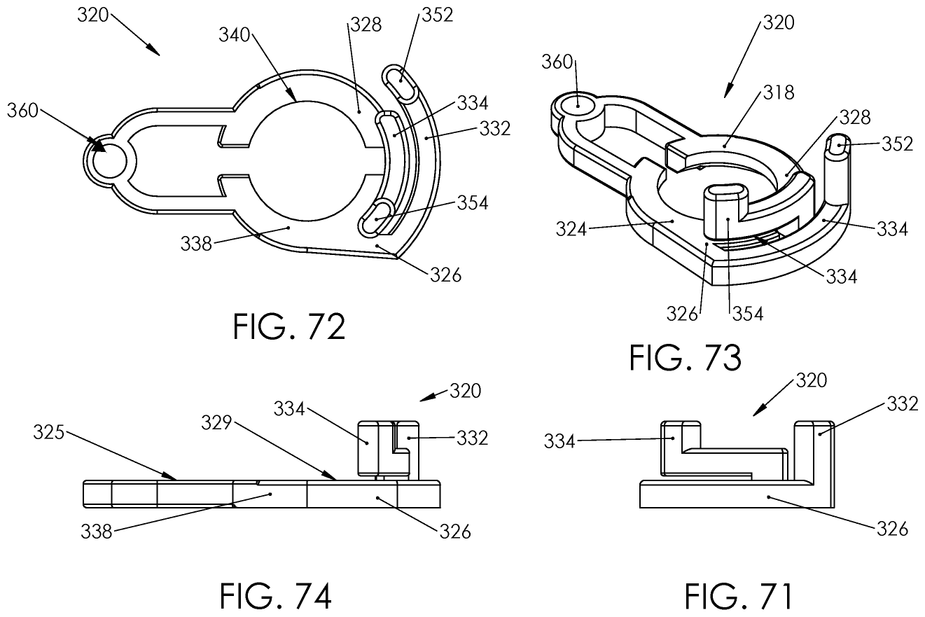

Referring to FIGS. 50-77, in accordance with embodiments of the invention, there is provided a cutting blade 300 for use with a rotary trimmer head assembly 302 configured with one or more swiveling blade receptacles 104. Preferably, as illustrated in FIGS. 50-64, the cutting blade 300 includes an elongated body 306 extending along a longitudinal axis 308 forming two opposing planar surfaces 310 and 312. The body 306 has a trimmer head connecting end portion 314 and a cutting end portion 316. Preferably, the connecting end portion 316 defines a blade mount aperture 318 adapted to receive the swiveling blade receptacle 104. FIG. 50 illustrates the blade mount aperture 318 as configured to receive the swiveling blade receptacle 104. The cutting end portion 316 preferably forms at least one cutting edge 319.

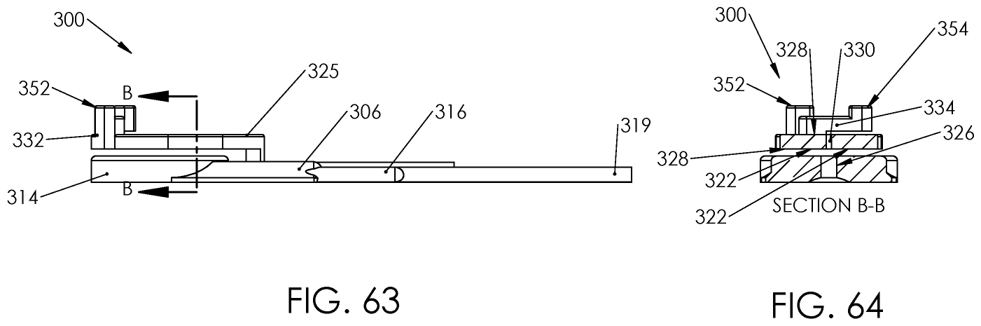

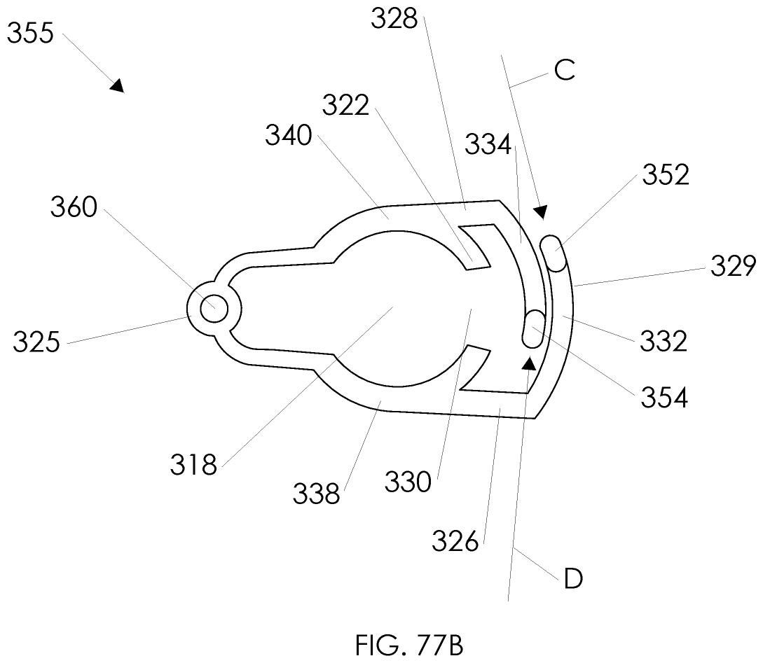

As illustrated in FIGS. 50-74, the connecting end portion 314 has an inverse spring collar assembly 320 sized and configured to firmly and removably receive and secure a portion of an outer cylindrical channel 156 of the swiveling blade receptacle 104. The inverse spring collar assembly 320 preferably includes a clamp 322 having a ring portion 324 with a pair of opposite ends 338 and 340. The ring portion 324 located at a proximal end 325 with opposing arms 326 and 328 defining a clamp opening 330. FIG. 64, as a cross section of FIG. 63 along section B-B, illustrates the details of the clamp opening 330 disposed between opposing arms 326 and 328. The opposing arms 326 and 328 have respective extension arms 332 and 334 extending in overlapping relation with one another and the extension arms 332 and 334 constitute actuating members by which an expanding force, represented by arrow C and arrow D can be applied to the ends 338 and 340 of the ring portion 324 for flexing the clamp 322 to an expanded or dilated open position, as illustrated in FIG. 77B. In the expanded open position, the clamp 322 is adapted to readily receive the swiveling blade receptacle 104 and a release of the expanding force, shown as arrow C and arrow D applied to the opposing arms 326 and 328 permits contraction of the clamp 322 into the channel 156 of the swiveling blade receptacle 104. FIG. 51, a cross section of FIG. 50 along section A-A, depicts the interior detail of the blade mount aperture 318 whereby the ring portion 324 is adapted to securely abut the channel 156 of the swiveling blade receptacle 104 upon contraction of the clamp 322.

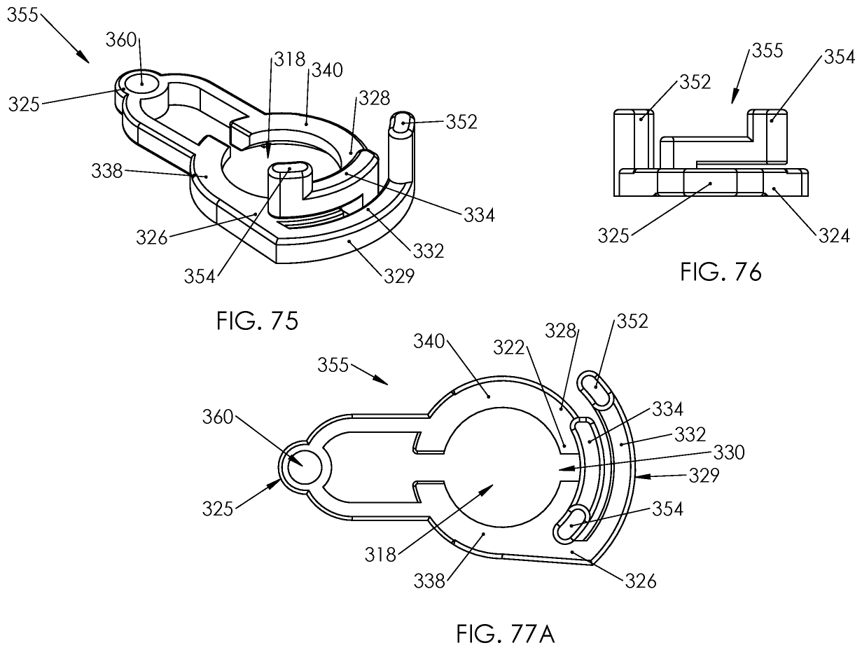

In one embodiment, the proximal end 325 of the clamp 322 defines an aperture 360 configured to receive a pin 362, as shown in FIGS. 75 and 77.

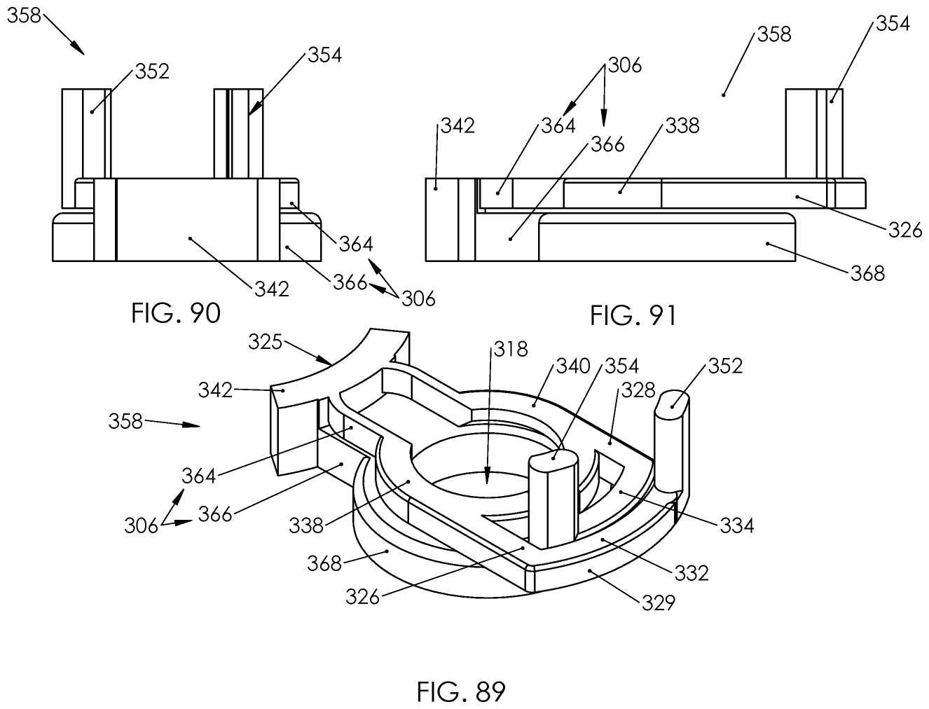

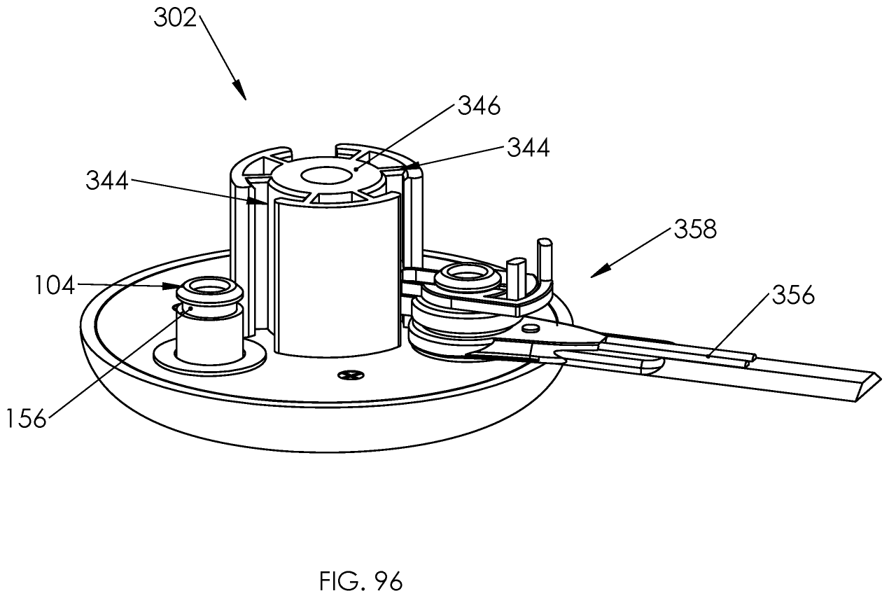

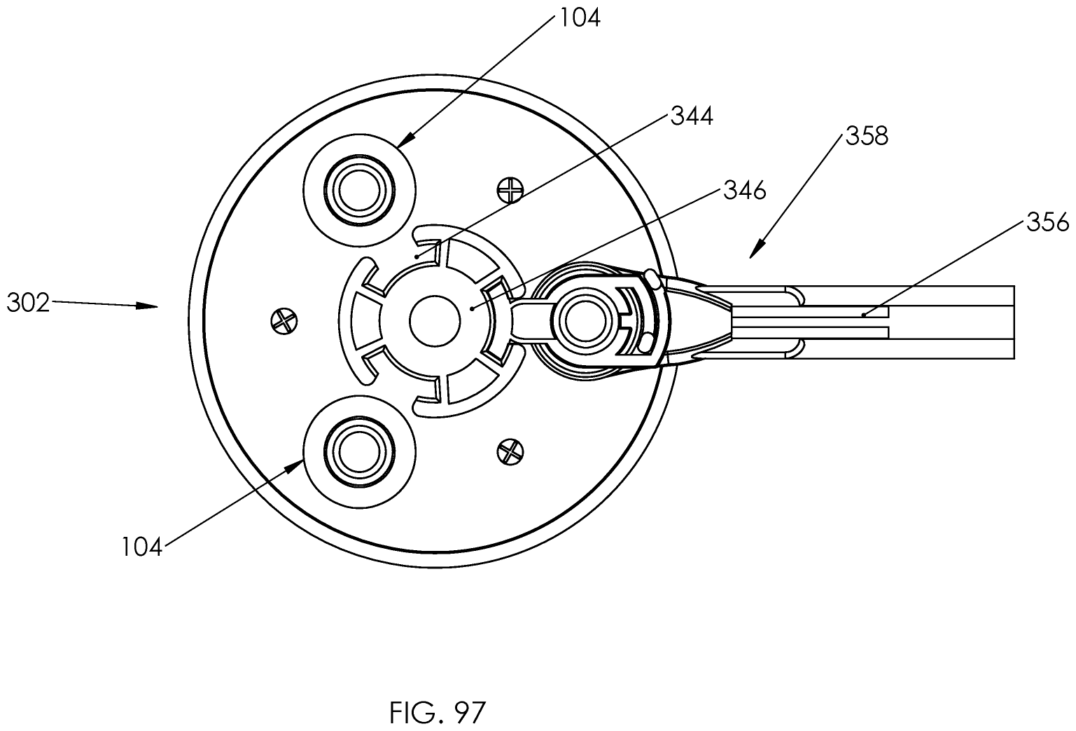

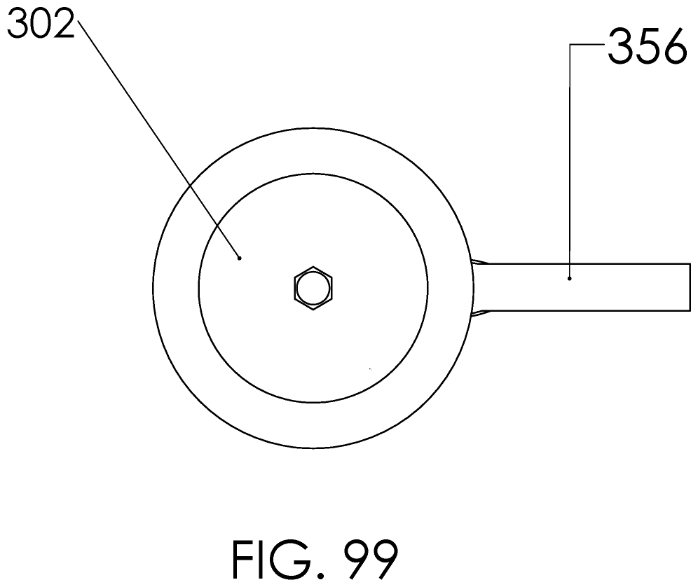

In another embodiment, as illustrated in FIGS. 89-100, the cutting blade 300 includes a connector 342 disposed at the proximal end 325 of the clamp 322 and preferably configured to mate in a lock and key type configuration, for example, with a channel 344 defined by a center post 346 of the rotary trimmer head assembly 302.

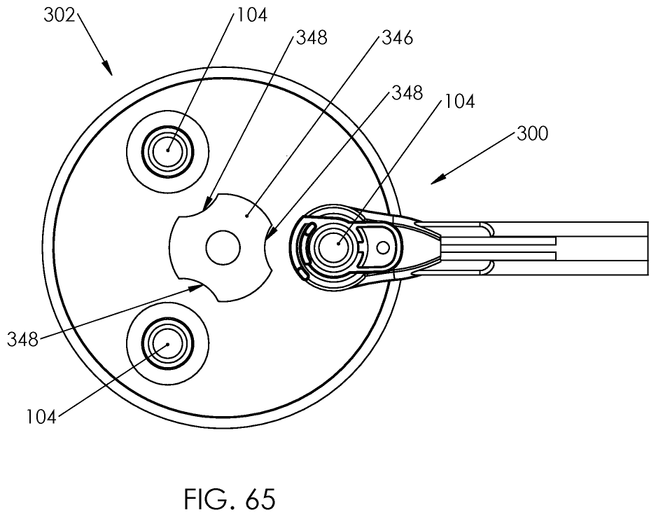

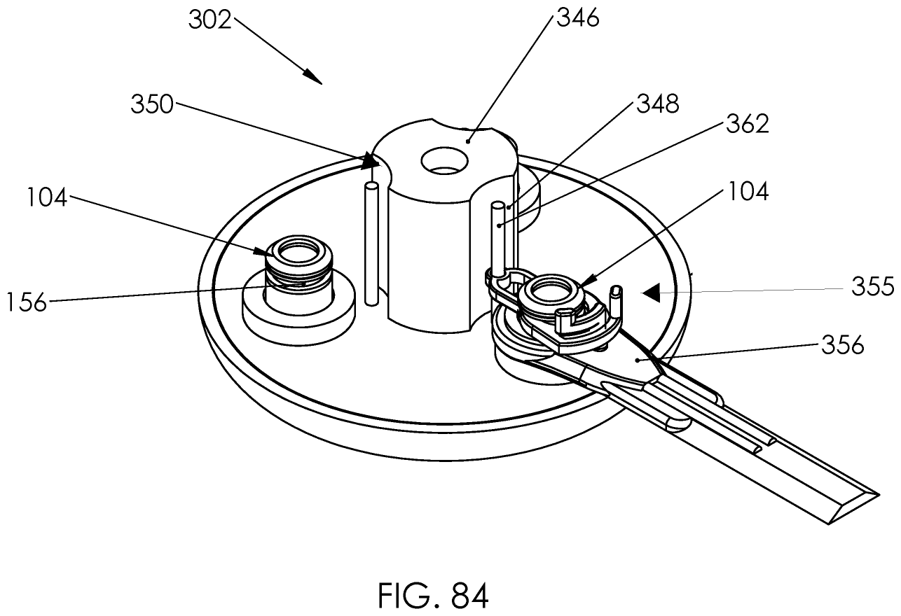

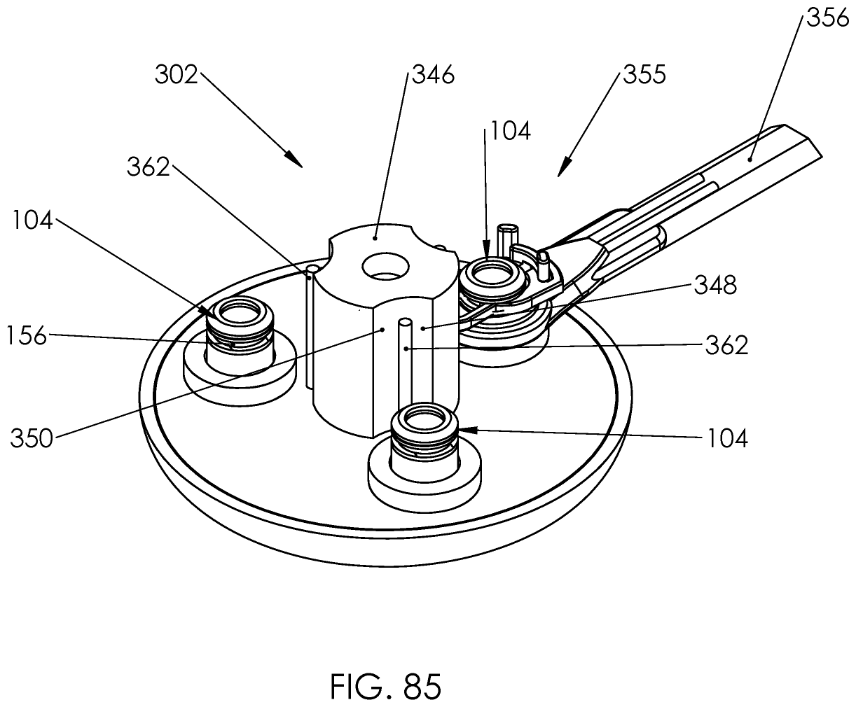

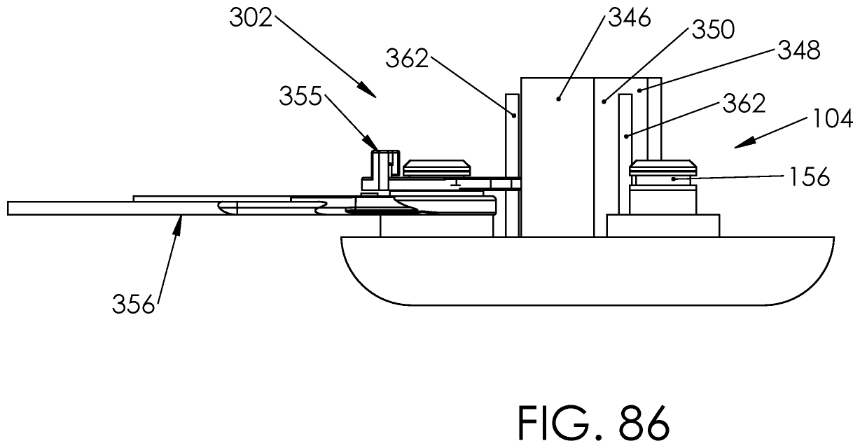

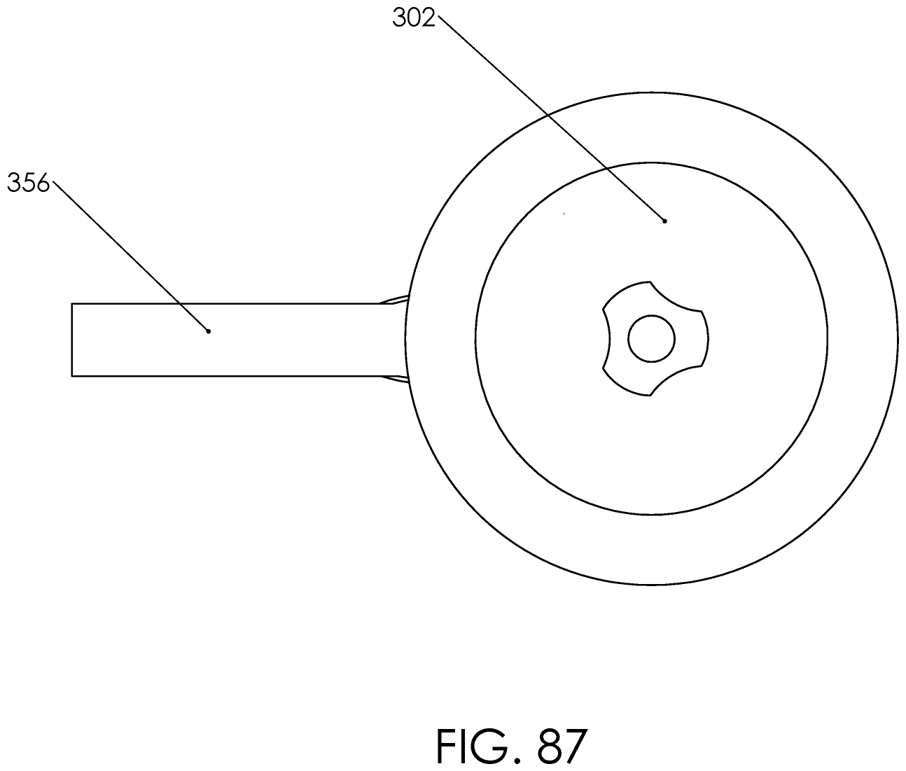

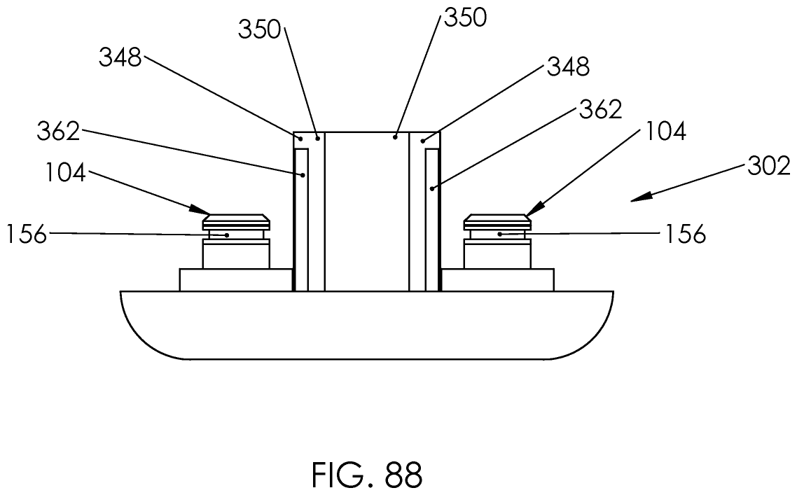

In one embodiment, as illustrated in FIGS. 65-68, the center post 346 of the trimmer head 302 defines at least one annular groove 348 disposed along an outer surface 350 of the center post 346. Preferably, the pin 340 is positioned within the annular groove 348 as shown in FIGS. 84-88.

In one embodiment, the center post 346 of the trimmer head 302 defines at least one annular groove 348 disposed along an outer surface 350 of the center post 346. Preferably, the annular groove 348 is configured to allow for rotation of the cutting blade 300 when clamped to the swiveling blade receptacle 104, as shown in FIGS. 65-68.

In yet another embodiment, as illustrated in FIGS. 75-77 and 89-91, at least one or more opposable finger levers 352 and 354 are disposed at the ends of the opposing arms 326 and 328.

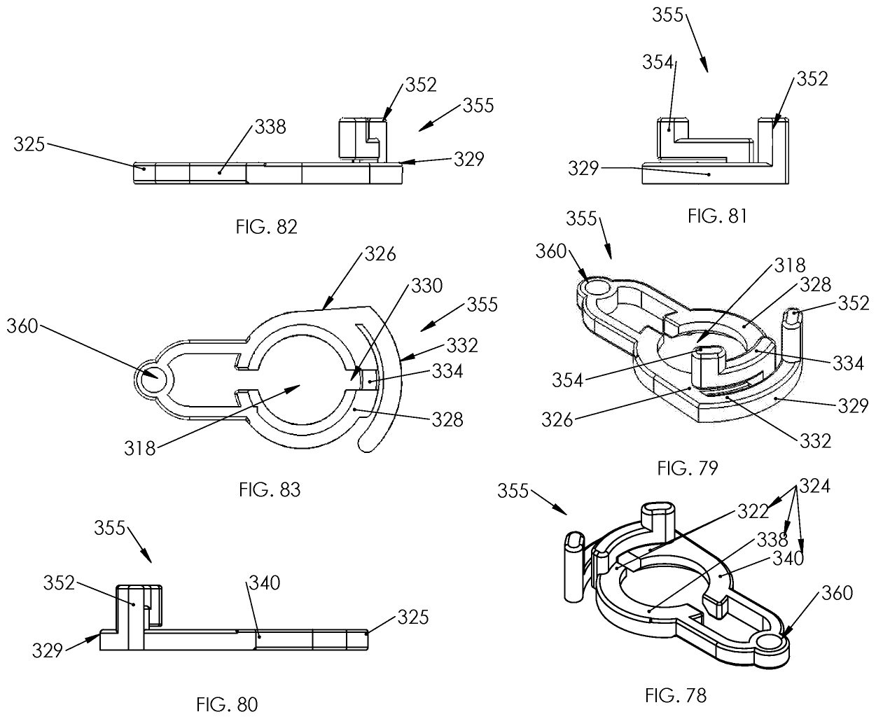

Referring to FIGS. 78-88, in accordance with embodiments of the invention, there is provided an inverse spring collar trimmer member retention assembly 355 sized and configured to firmly and removably receive and secure a trimmer member 356 to a swiveling blade receptacle 104. Preferably, the inverse spring collar assembly 355 has a clamp 322 having a ring portion 324 having a pair of opposite ends, a distal end 329 opposite a proximal end 325. Preferably, the proximal end 325 of the clamp 322 defines an aperture 360 configured to receive a pin 362 vertically extending from a rotary trimmer head 302, as shown in FIG. 84. The clamp 322 defines a clamp opening 330.

A pair of opposing arms 326 and 328 are disposed at the distal end 329 of the clamp 322. The opposing arms 326 and 328 are connected with opposite ends of the ring portion 324 and extend outwardly in substantially opposite directions and in a crossing or overlapping relation to each other, as shown in FIGS. 75-83. As illustrated in FIG. 77B, the arms 326 and 328 constitute actuating members by which an expanding force, represented by arrow C and arrow D, can be applied to the ends 338 and 340 of the ring member 324 for flexing the clamp 322 to an expanded or dilated open position. When in the expanded open position, the clamp 322 is adapted to readily receive the swiveling blade receptacle 104. A release of the expanding force, represented by arrow C and arrow D, applied to the opposing arms 326 and 328 permits contraction of the clamp 322 into a channel 156 of the swiveling blade receptacle 104.

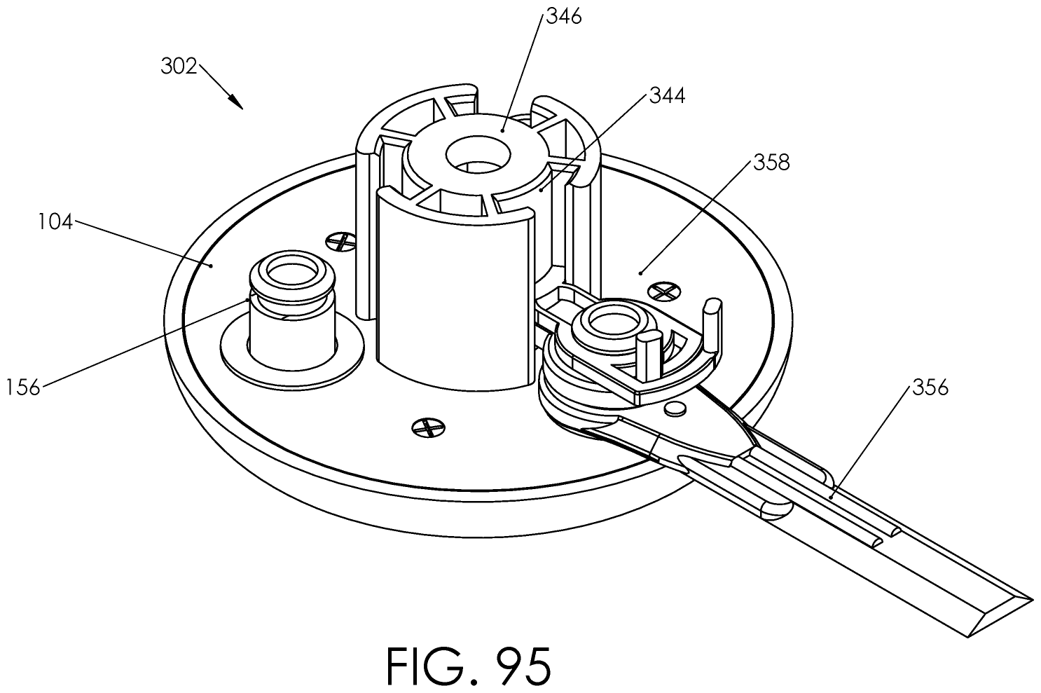

In accordance with embodiments of the invention, there is provided an inverse spring collar trimmer member retention assembly 358 sized and configured to firmly and removably receive and secure a trimmer member 356 to a swiveling blade receptacle 104. The inverse spring collar assembly 358 includes a clamp 322 having a ring portion 324. The ring portion 324 has a distal end 329 opposite a proximal end 325. The proximal end 325 preferably includes a connector 340 disposed at the proximal end 325 of the clamp 322 and the connector 342 is configured to mate with a channel 344 defined by a center post 346 of the rotary trimmer head assembly 302, as illustrated in FIGS. 95-100. The clamp 322 defines a clamp opening 330.

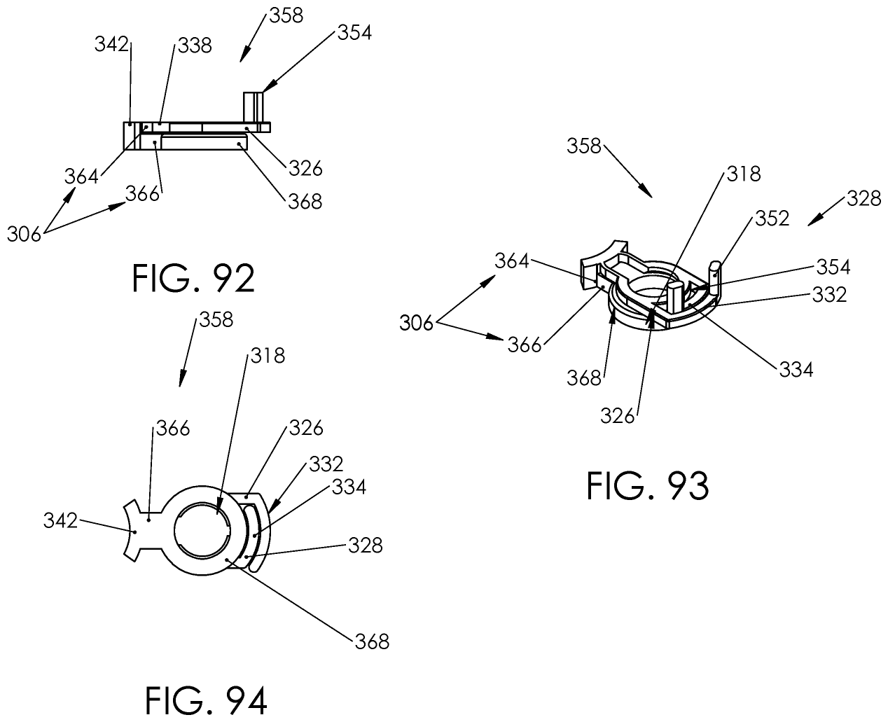

As illustrated in FIGS. 92-100, a pair of opposing arms 326 and 328 is disposed at the distal end 329 of the clamp 322. The opposing arms 326 and 328 are connected with opposite ends of the ring portion 324 and extend outwardly in substantially opposite directions and in a crossing or overlapping relation to each other. The arms 326 and 328 constitute actuating members by which an expanding force, represented by arrow C and arrow D, can be applied to the ends 338 and 340 of the ring member 324 for flexing the clamp 322 to an expanded or dilated open position, as shown in FIG. 77B. When the clamp 322 is in the expanded open position, the clamp 322 is adapted to readily receive the swiveling blade receptacle 104. A release of the expanding force, represented by arrow C and arrow D, applied to the opposing arms 326 and 328 permits contraction of the clamp 322 into a channel 156 of the swiveling blade receptacle 104.

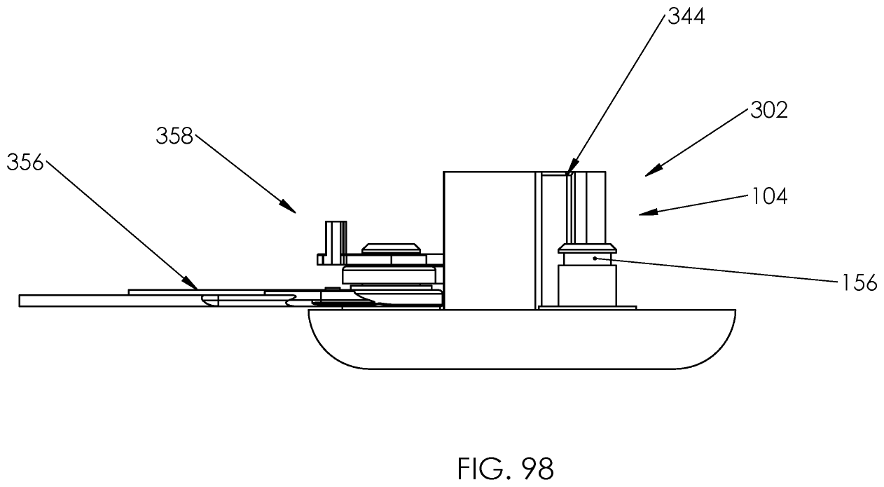

Referring to FIGS. 98-100, in accordance with embodiments of the invention, there is provided an inverse spring collar trimmer member retention assembly 358 sized and configured to firmly and removably receive and secure a portion of an outer cylindrical channel 156 of a swiveling blade receptacle 104. The inverse spring collar trimmer member retention assembly 358 includes an elongated body 306 having a distal end 329 opposite a proximal end 325, the body 306 having an upper elongated member 364 and a lower elongated member 366. As shown in FIGS. 89-91, a washer 368 is disposed at the proximal end 325 of the lower elongated member 366 and configured to allow for the passage of the swiveling blade receptacle 104 therethrough. An inverse spring collar assembly 355 is disposed at the proximal end 325 of the upper elongated member 364.

As shown in FIGS. 89-100, the spring collar assembly 358 includes a clamp 322 having a ring portion 324 with a pair of opposite ends 338 and 340. The ring portion 324 having opposing arms 326 and 328 defining a clamp opening 330. The opposing arms 326 and 328 have respective extension arms 332 and 334 extending in overlapping relation with one another and the extension arms 332 and 334 constitute actuating members 352 and 354 by which an expanding force, represented as arrow C and arrow D, can be applied to the ends 338 and 340 of the ring portion 324 for flexing the clamp 322 to an expanded or dilated open position, shown in FIG. 77B. When in the expanded open position, the clamp 322 is adapted to readily receive the swiveling blade receptacle 104. A release of the expanding force, as represented by arrow C and arrow D, applied to the opposing arms 326 and 328 permits contraction of the clamp 322 into the channel 156 of the swiveling blade receptacle 104.

In another embodiment, as illustrated in FIGS. 89-100, the cutting blade 300 includes a connector 342 disposed at the proximal end 325 of the clamp 322 and preferably configured to mate in a lock and key type configuration, for example, with a channel 344 defined by a center post 346 of the rotary trimmer head assembly 302.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

What is claimed is:

1. A cutting blade for use with a rotary trimmer head assembly configured with one or more swiveling blade receptacles, the blade comprising:
an elongated body extending along a longitudinal axis, the body forming two opposing planar surfaces and the body comprising a trimmer head connecting end portion and a cutting end portion, the connecting end portion defining a blade mount aperture adapted to receive the swiveling blade receptacle, the cutting end portion forming at least one cutting edge;
wherein the connecting end portion comprises a spring collar assembly sized and configured to firmly and removably receive and secure a portion of an outer cylindrical surface of the swiveling blade receptacle, said spring collar assembly comprising:
a pair of opposing levers having two ends, each lever having a handle toward one of said ends thereof and a curved jaw toward the other of said ends, said curved jaws defining a collar aperture in coaxial alignment with the blade mount aperture, said levers fixedly connected to respective pivot arms radially extending from a pivotal abutment disposed intermediate said two ends of each lever, wherein squeezing together said handles of the levers increases a diameter of the collar aperture.

2. The cutting blade of claim 1, wherein the cutting end portion forms two opposed cutting edges.

3. A spring collar locking assembly for use with a rotary trimmer head assembly configured with one or more swiveling receptacles, the spring collar locking assembly comprising:
a planar body member defining a blade mount aperture adapted to receive the swiveling blade receptacle, said planar body adapted to receive one or more tool members; and
a pair of opposing levers mounted to the planar body, each lever having two ends, said lever having a handle toward one of said ends thereof and a curved jaw toward the other of said ends, said curved jaws defining a collar aperture in alignment with the blade mount aperture, said levers having a pivotal abutment intermediate said two ends of said levers, wherein squeezing together said handles of the levers increases a diameter of the collar aperture.

4. The cutting blade of claim 3, wherein the pivotal abutment comprises two fold at the vertex of the V-shape.

5. The spring collar assembly of claim 3, wherein the tool member is a cutting blade.

6. The spring collar assembly of claim 3, wherein the tool member is a trimmer line.

7. The spring collar assembly of claim 3, wherein the tool member is a blower blade.

8. The spring collar assembly of claim 3, wherein the tool member is a broom.

9. The spring collar assembly of claim 3, wherein the tool member is a propeller.

10. A trimmer member receptacle configured for use with a rotary trimmer head assembly, comprising:
a cylindrical body having an upper portion opposite a lower portion, said upper portion defining a channel adapted to receive a spring collar locking assembly, the lower portion comprising a cylindrical flange configured for attachment to the rotary trimmer head assembly.

11. The trimmer member receptacle of claim 10, wherein the cylindrical body further defines a passage therethrough, said passage defined by a top wall, a bottom wall and a pair of opposing side walls connecting the top and bottom walls.

12. The trimmer member receptacle of claim 10, wherein said receptacle is fixed to the rotary trimmer head assembly.

13. The trimmer member receptacle of claim 10, wherein said receptacle is dynamically connected to the rotary trimmer head assembly.

14. A lawn mower blade assembly comprising:
a rotatable planar body defining a centrally disposed drive mount opening configured for receiving a mower motor drive shaft, said planar body comprising two or more elongated arms extending outwardly therefrom, each arm having a proximal end opposite a distal end, said distal end of each arm defining a receptacle aperture configured to receive a swiveling blade receptacle therethrough;
at least one swiveling blade receptacle having a cylindrical body removably inserted through said receptacle aperture, said cylindrical body comprising an upper portion opposite a lower portion, said upper portion defining an annular ring channel, said lower portion comprising a cylindrical flange extending radially outwardly from said body; and
a cutting blade comprising an elongated body having a cutting end portion and a connecting end portion, the cutting end portion forming at least one cutting edge, the connecting end portion defining a blade mount aperture adapted to receive the swiveling blade receptacle, the connecting end portion comprising a spring collar assembly having a pair of opposing levers having two ends, each lever having a handle toward one of said ends thereof and a curved jaw toward the other of said ends, said curved jaws defining a collar aperture in coaxial alignment with the blade mount aperture, said levers having a pivotal abutment intermediate said two ends of said levers, wherein squeezing together said handles of the levers increases a diameter of the collar aperture, wherein said jaws are sized and configured to firmly and removably engage and secure the annular ring channel of the upper portion of the swiveling blade receptacle, wherein said cutting blade is secured to said rotatable planar body when said curved jaws engage said annular ring of the swiveling blade receptacle.

15. The lawn mower blade assembly of claim 14, wherein the connecting end portion of the cutting blade forms a washer, wherein said washer forms the blade mount aperture.

16. The lawn mower blade assembly of claim 14, wherein the swiveling blade receptacle is freely spinnable within said receptacle aperture and coaxially aligned concentric with the receptacle aperture.

17. The lawn mower blade assembly of claim 14, wherein a top end of the upper portion of the swiveling blade receptacle is beveled.

18. The lawn mower blade assembly of claim 14, wherein the rotatable planar body comprises three radially extending arms, each arm defining a receptacle aperture configured to receive a swiveling blade receptacle therethrough, each arm radially spaced equally.

19. The lawn mower blade assembly of claim 14, wherein the rotatable planar body comprises four radially extending arms, each arm defining a receptacle aperture configured to receive a swiveling blade receptacle therethrough, each arm radially spaced equally.

20. The lawn mower blade assembly of claim 14, wherein at least one of said two or more elongated arms has a longitudinal axis that departs at an acute angle relative to the planar body, wherein the distal end of the at least one of said two or more elongated arms departs at an angle relative to the longitudinal axis, wherein said distal end has a horizontal plane parallel to the planar body.

21. The lawn mower blade assembly of claim 14, further comprising an elongated batten disposed along at least a top or bottom surface of the rotatable planar body and two or more elongated extending arms.

22. The lawn mower blade assembly of claim 14, further comprising an elongated batten formed along a top surface of the rotatable planar body and two or more elongated extending arms, wherein said batten defines a channel along a bottom surface of said rotatable planar body and two or more elongated extending arms.

23. The lawn mower blade assembly of claim 14, wherein the cutting end portion forms two opposed cutting edges.

24. The lawn mower blade assembly of claim 14, wherein said cutting end portion of the cutting blade comprises a tip at the end thereof, said tip having a corner opposite to the at least one cutting edge, said corner being tilted upwardly to define a sail.

25. A cutting blade for use with a lawn mower blade assembly, comprising:
an elongated body having a cutting end portion and a connecting end portion, the cutting end portion forming at least one cutting edge, the connecting end portion defining a blade mount aperture adapted to receive a swiveling blade receptacle;
the connecting end portion comprising a spring collar assembly having a pair of opposing levers having two ends, each lever having a handle toward one of said ends thereof and a curved jaw toward the other of said ends, said curved jaws defining a collar aperture in coaxial alignment with the blade mount aperture, said levers having a pivotal abutment intermediate said two ends of said levers;
wherein squeezing together said handles of the levers increases a diameter of the collar aperture, and
wherein said jaws are sized and configured to firmly and removably engage and secure an annular ring channel of an upper portion of a swiveling blade receptacle.

26. The lawn mower blade assembly of claim 25, wherein the connecting end portion of the cutting blade forms a washer, wherein said washer forms the blade mount aperture.

27. The lawn mower blade assembly of claim 25, wherein the cutting end portion forms two opposed cutting edges.

28. The lawn mower blade assembly of claim 25, wherein said cutting end portion of the cutting blade comprises a tip at the end thereof, said tip having a corner opposite to the at least one cutting edge, said corner being tilted upwardly to define a sail.
